(19) United States
(12) Patent Application Publication
(10) Pub. No.: US 2020/0053979 A1
(43) Pub. Date: Feb. 20, 2020

(54) PET WINDOW

(71) Applicant: William J. Johnson, Flower Mound, TX (US)

(72) Inventor: William J. Johnson, Flower Mound, TX (US)

(21) Appl. No.: 16/164,771

(22) Filed: Oct. 18, 2018

Related U.S. Application Data
(63) Continuation-in-part of application No. 16/104,848, filed on Aug. 17, 2018.

(51) Int. Cl. A01K 1/035; E06B 7/32

(52) U.S. Cl. CPC A01K 1/035; E06B 7/32

(57) ABSTRACT

A pet window hosts a pet door wherein the pet window replaces an existing window screen. For example, the pet window fits securely into a window screen track adjacent and parallel to a window of a movable window sash, in a similar manner as the screen being replaced. The pet window may provide many options: insulation characteristics to minimize outside weather affecting home inside conditions, accessory window(s), solar panel integration, LED light(s), attached gauge(s), attached electric appliance(s), adaptable electric connectivity, an exterior awning, panel componentization, window screen track adapters, and any of a large range of decorative themes, colors, appearances, and other options.

### CROSS-REFERENCES TO RELATED APPLICATIONS

This application is a continuation in part and claims benefit of application Ser. No. 16/104,848 filed Aug. 17, 2018 and entitled “Pet Window”, which application is hereby incorporated by reference in its entirety as though fully and completely set forth herein.

### TECHNICAL FIELD

The present disclosure relates generally to pet doors and pet owner products, and more specifically to a window screen replacement for hosting a pet door.

### BACKGROUND

Pets, for example dogs and cats, help themselves indoors or outdoors by use of a pet door. Pet doors are convenient for a pet owner, and require little time to train a pet in using the pet door. Many pet owners would rather not permanently install a pet door into an expensive door or wall. While pet doors can be locked for ingress and egress, construction that is light enough for a pet to operate is also easily penetrated by a determined thief with tools for breaking into a home. Permanently installed pet doors may also allow uninvited or wild animals to enter a home if the home owner forgets to lock the pet door.

Some pet doors can be installed into a partially open window. Many homes have security/alarm systems installed for detecting open windows or doors. Pet doors for partially open windows interfere with operations of a home security system and require the home owner to inconveniently remove the pet door from the window when securing the home. Otherwise, the security/alarm system must be compromised to prevent the window installed pet door from interfering with operation. Maintaining an open window for an installed pet door has major security issues. Some pet doors can be installed into a window screen. The screen lacks strength in preventing a forced entry from outside, and a pet door installed into a screen requires outside temperatures during pet door use to match home inside temperatures so home air conditioning isn't adversely affected.

Prior devices fail to fulfill their particular objectives and requirements, so a new portable pet window disclosed herein appears to overcome a large number of pet owner concerns with installing a satisfactory pet door.

### SUMMARY

The present disclosure includes embodiments of a MyLow Pet Window™ product, system, apparatus, and article of manufacture implemented to host a pet door. The Pet Window™ is hereinafter referred to as a pet window. A pet window including a panel (i.e. same term used for combinative apparatus of a plurality of panels) hosts a market available pet door wherein the panel replaces an existing window screen. The panel fits securely adjacent and parallel to a window of a movable (e.g. sliding, opening, closing, operating, or the like) window sash (i.e. the window portion, usually containing glass, that may be opened or closed which is adjacent the window screen), for example into a window screen track, in a similar manner as the screen being replaced that is received into the same window screen track. An existing home window (i.e. the window sash) can be opened or closed without interaction with the pet window just as there is no interaction with the window screen. The window sash remains fully operable adjacent the panel. Insulation properties of the pet window permit use without concern for outside temperatures or other weather conditions. A pet owner is also reminded with the existing home security/alarm system indication in the usual manner to close the window when desired. It is recommended a pet door with suitable insulation properties be installed into the pet window. A pet window may be produced with a suitable pet door already installed, or integrated therein at manufacture time.

One aspect of some embodiments is in providing a low cost solution as comprised by a product and maintaining of the product. Practical solutions are manufactured inexpensively. While there are luxury options disclosed herein to include with the pet window, a basic pet window is inexpensive, light to handle, and may be customized for a particular window. Preferably, the main panel of the pet window is sized identically to the outermost dimensions of the window screen frame being replaced. The panel may be sized for supporting a plurality of different sized windows by providing extra panel area in height and width that can be trimmed by a consumer to fit the window screen replacement. This allows sale of a single pet window product for a targeted market sector of popular sized windows, perhaps by geographical location. A pet window may be a fully customized highly luxurious solution for customers wanting the best for their pet, or a low cost mass produced product customizable after purchase, and with a-la-carte options.

In one customer service example, a customer brings an existing screen, or dimensions thereof, to a licensed pet window service company which in turn matches the screen size and consumer preferred options. The customer returns home with a fully operable pet window having desired options incorporated. The pet window service company may keep standard sized panels, or panels each with a pet door installed, or panels each with popular options installed, or the like, to minimize effort in trimming and customization for a particular customer.

In another licensed customer service example, a customer visits a pet window order website, specifies screen dimensions and desired options, and is directed to the nearest store to pick up (or accept delivery of) the pet window. Such a website facilitates finding the nearest store location to the customer, accepts payment (e.g. debit/credit card, Paypal™, bitcoin, or the like), and notifies the nearest store to ensure the ready-made pet window is available for pickup, convenient customer scheduling of pickup, or for delivery to the customer by customer service.

Another aspect of some embodiments is in providing a very low cost solution as comprised by a product, mailing of the product, and maintaining of the product. Practical solutions are manufactured inexpensively. Also, an inexpensive article of manufacture (e.g. a product) can be conveniently packaged for minimum cost mailing because of component length and light weight. Pet window components can be controllably manufactured for minimizing the length, weight, and dimensions thereof to minimize mailing and shipping costs. Product instructions are brief. No tools or glues are required for assembly in many preferred embodiments. Embodiment products are packaged as components convenient for assembly. Product installation is very easy and quick while preventing future maintenance.

Another aspect of some embodiments is in producing many embodiments for decorative purposes, personal tastes, desired themes, and competing licensable products to create a new market category for pet windows that replace screens. The pet window may provide many different useful options for insulation characteristics appropriate during any outside weather conditions such as temperature, wind, rain, snow, or storms. A pet owner opens the window for permitting outgoing and/or ingoing access to a pet, and can close the window for securing the home from outside access and proper setting of a home security/alarm system. Options discussed below include accessory window(s), solar panel integration, LED light(s), attached gauge(s), attached electric appliance(s), adaptable electric connectivity, an exterior awning, panel componentization, window screen track adapters, and any of a large range of decorative themes, colors, appearances, and other options.

### DESCRIPTION OF DRAWINGS

The above and further aspects of this disclosure are discussed with reference to the following description in conjunction with the accompanying drawings, in which like numerals indicate like structural elements and features in various figures. A drawing in which an element first appears is indicated by the leftmost digit(s) in the corresponding reference number. There is no guarantee there are descriptions in this specification for explaining every novel feature found in the drawings. The figures depict one or more implementations by way of example only, not by way of limitation.

FIG. 1A depicts an inside facing surface view of a first preferred embodiment of a pet window;

FIG. 1B depicts an outside facing surface view of the first preferred embodiment of the pet window of FIG. 1A;

FIG. 1C depicts an inside facing surface view of a second preferred embodiment of a pet window;

FIG. 1D depicts an outside facing surface view of a third preferred embodiment of a pet window;

FIG. 1 E depicts an inside facing surface view of a fourth preferred embodiment of a pet window;

FIGS. 1F and 1G depict a profile illustration of a preferred embodiment of a pet window;

FIGS. 1H through 1J depict a panel componentization illustration of a preferred embodiment of a pet window;

FIGS. 2A through 2H depict illustrations for discussing panel retainers;

FIGS. 3A and 3B illustrate use of a pet window for communicating a pet window over conventional pet door installations;

FIGS. 4A and 4B depict an inside facing surface view of the third preferred embodiment of a pet window for discussing options;

FIGS. 4C and 4D depict an inside facing surface view of a modified version of the third preferred embodiment of a pet window for discussing options;

FIGS. 5A through 5F depict embodiments for discussing pet window awning options; and

FIGS. 6A and 6B depict embodiments for discussing other useful pet window components.

### DETAILED DESCRIPTION

With reference now to detail of the drawings, the present disclosure is described. Novel features disclosed herein need not be provided as all or none. Certain features may be isolated in some embodiments, or may appear as any subset of features and functionality in other embodiments.

A pet window 100 preferred embodiment for replacing a window screen includes at least a substantially planar panel 102, an appropriately sized passageway 103 in panel 102 (and in an applicable adjacent shim block 110 if matching pet door 104 installation wall thickness specification) for hosting (receiving installation of) a pet door 104, and a panel retainer 106. The terminology “substantially planar panel” used herein depends on the embodiment product, system, apparatus, or article of manufacture, but refers to: 1) a single substantially planar panel 102; and 2) a plurality of substantially planar panels (i.e. sub-panels) combined adjacent each other to construct a panel 102 (both classes of embodiments optionally including any combination of the features (i.e. options, attributes, characteristics, or the like) disclosed herein). More specifically, the plurality of substantially planar panels refers to a combinative apparatus wherein a plurality of panels 102 (may also be referred to as sub-panels 102) are arranged adjacent each other to form a combination of panels 102 that in total comprise, or contribute to, a pet window 100, the combinative apparatus having dimensions sized for replacing a window screen adjacent a movable window sash. The combinatory apparatus may fit together like a jigsaw puzzle adjacent seams with mating engagement edge features, or panel 102 connections, thereby facilitating a secure engagement of the plurality of panels 102. The terminology “passageway” used herein depends on the embodiment product, system, apparatus, or article of manufacture, and refers to an actual aperture (or hole) existing through panel 102 from outside surface to opposite outside surface, or refers to marking(s) on panel 102 for identifying where to make (e.g. cut) said aperture (or hole), or refers to an area of panel 102 destined for said aperture (or hole) to host a pet door 104. Panel 102 is preferably constructed with a lightweight, dense, rigid, and water resistant foam board material, perhaps sandwiched by strengthening materials, for excellent insulation and reinforced strength. Panel 102 should provide a thermal barrier (i.e. weather barrier) preserving indoor air conditioning from outdoor weather conditions. In some product embodiments, perimeter insulation weather-strip, weather-seal, or weather resistant tape is provided for edges of a pet window 100 installation. In other embodiments, small screws (e.g. ½″ #4 Phillips) may be provided (i.e. further panel retainers) for the outside window frame perimeter to further help hold a pet window 100 firmly in place. Customizing cuts are facilitated using hand tools with many appropriate panel 102 materials, but pet windows 100 may be manufactured using high speed CNC equipment.

Pet door 104 may be any of a variety of market available pet doors provided passageway 103 and profile wall thickness of panel 102 (and an applicable adjacent shim block 110 if required) accommodates pet door 104 appropriately. Panel retainer 106 preferably emulates (i.e. emulates=imitates or improves) a window screen retaining mechanism of the target window screen being replaced. Some panel retainer designs provide superior retainer 106 retention of panel 102 in a window screen track. Panel 102 is at least partially secured within the window screen track. One preferred pet door 104 for use in pet window 100 is marketed by Ideal Pet and has a transparent rigid door with insulated edges for wall thickness installations of 1.25 to 1.75 inches, in which case the total profile thickness of panel 102 (and an applicable shim block 110) is 1.25 to 1.75 inches. Pet window 100 may further include a variety of options, from basic to luxury, as described below. In many cases, a step may be helpful at the inside and/or outside of the home for the pet stepping up to the window sill for exit or entry of pet window 100, however, cats have an easier time than dogs using pet window 100 without a step when the window sill is significantly at a higher elevation than a floor or ground near the window sill associated with a pet window 100.

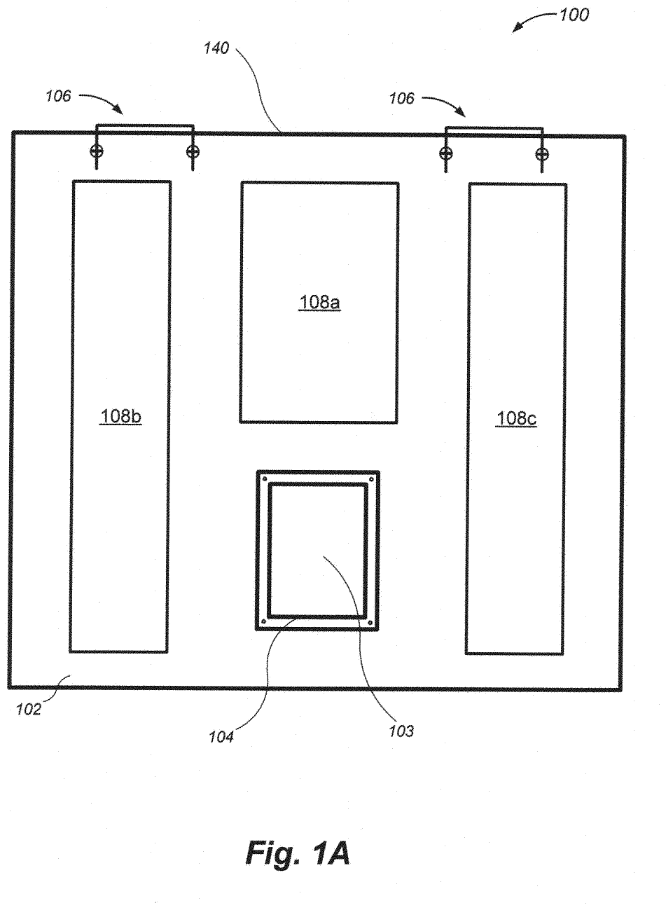

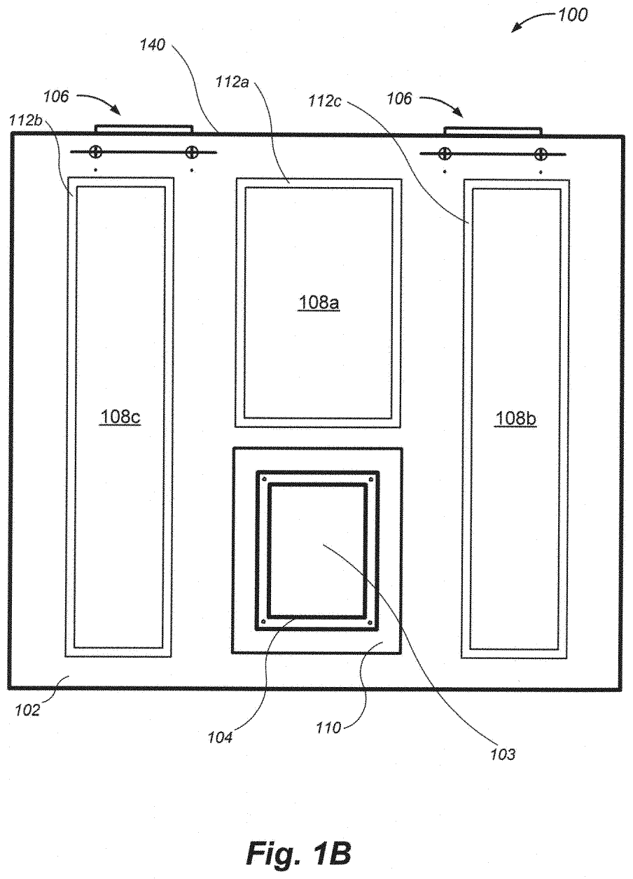

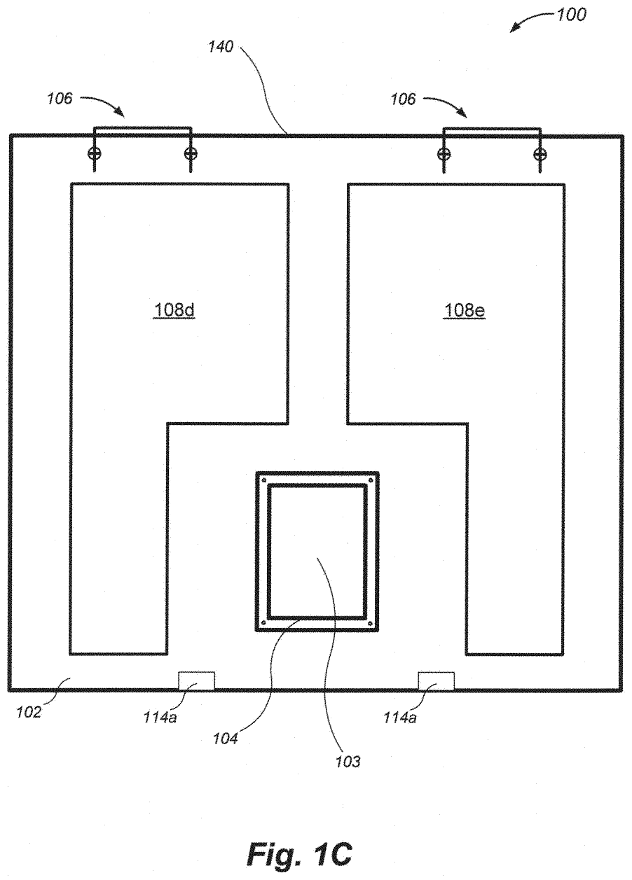

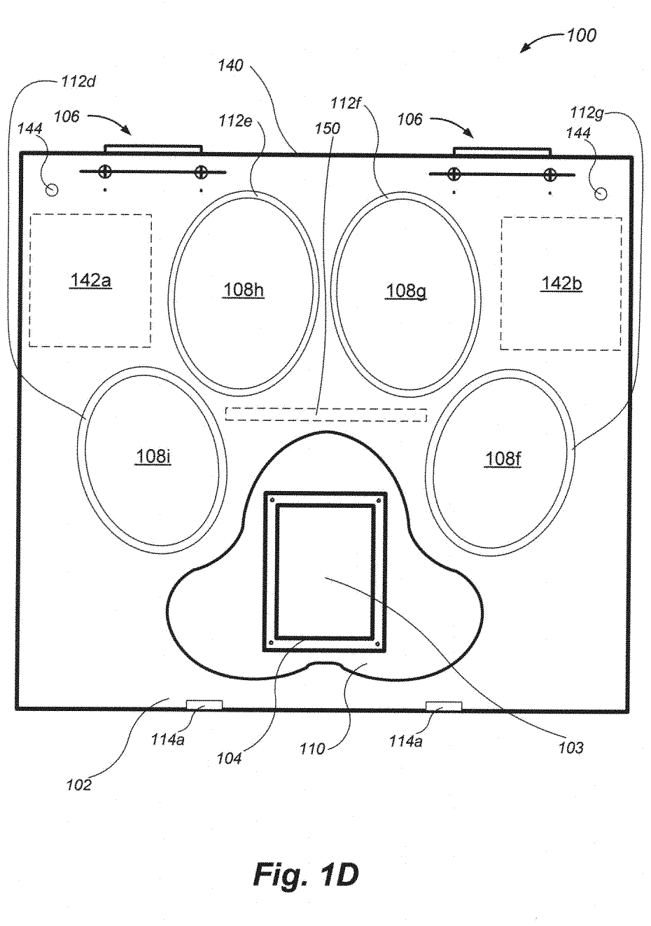

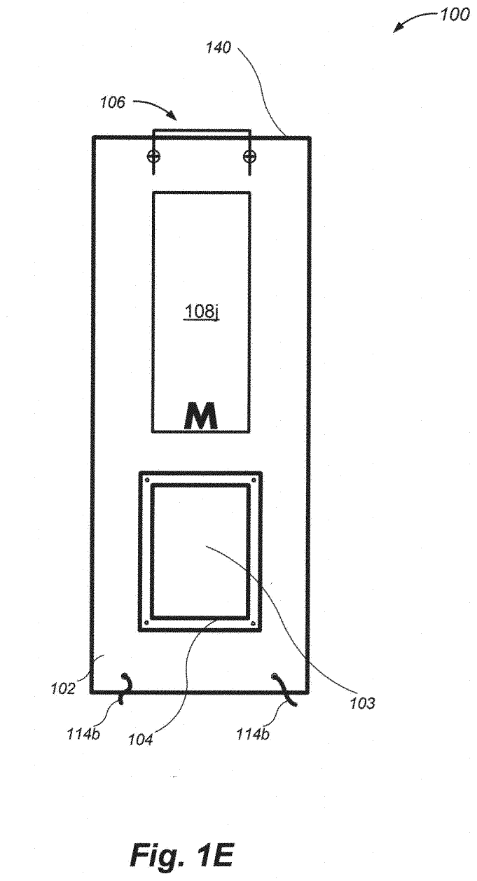

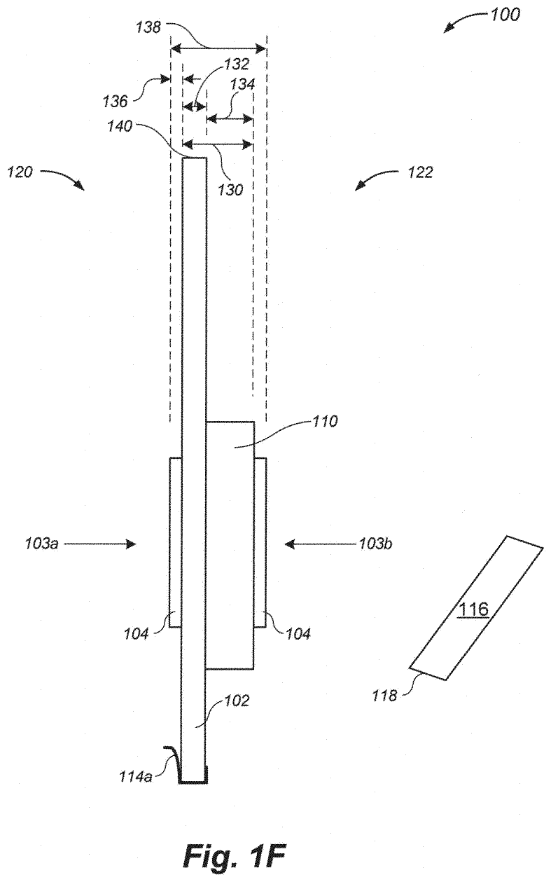

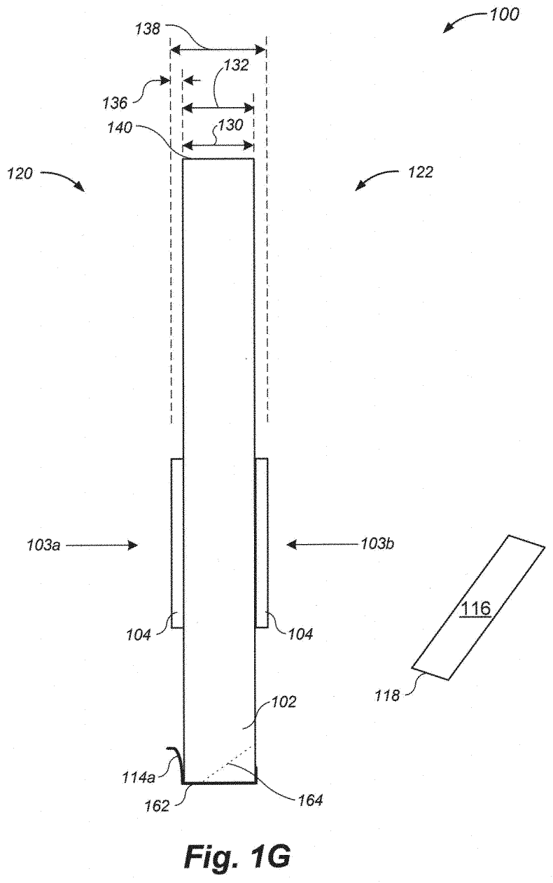

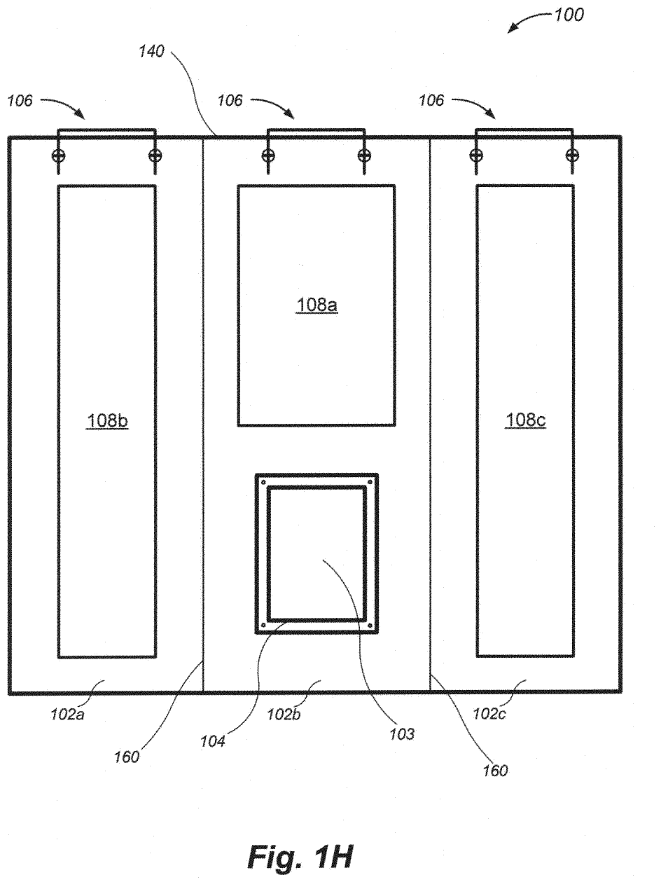

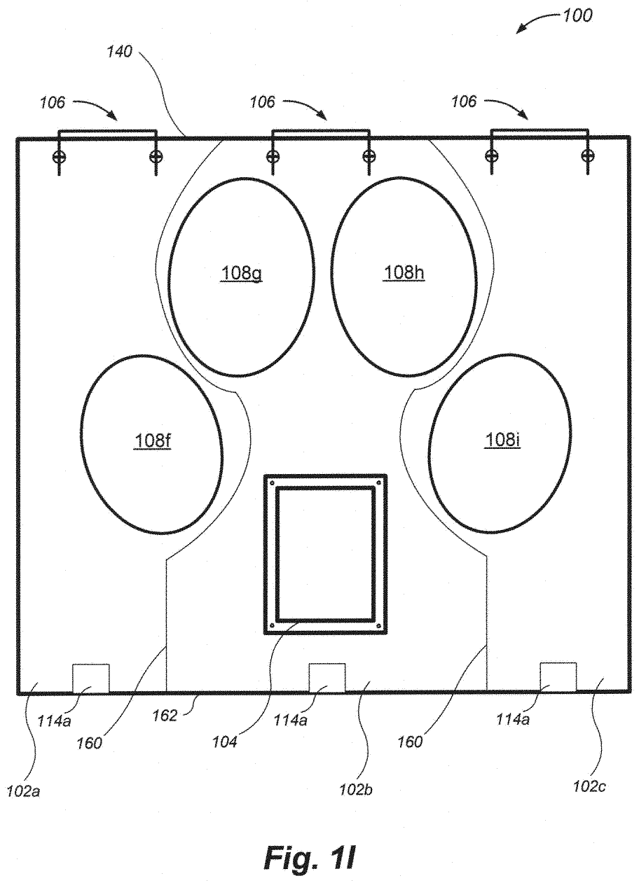

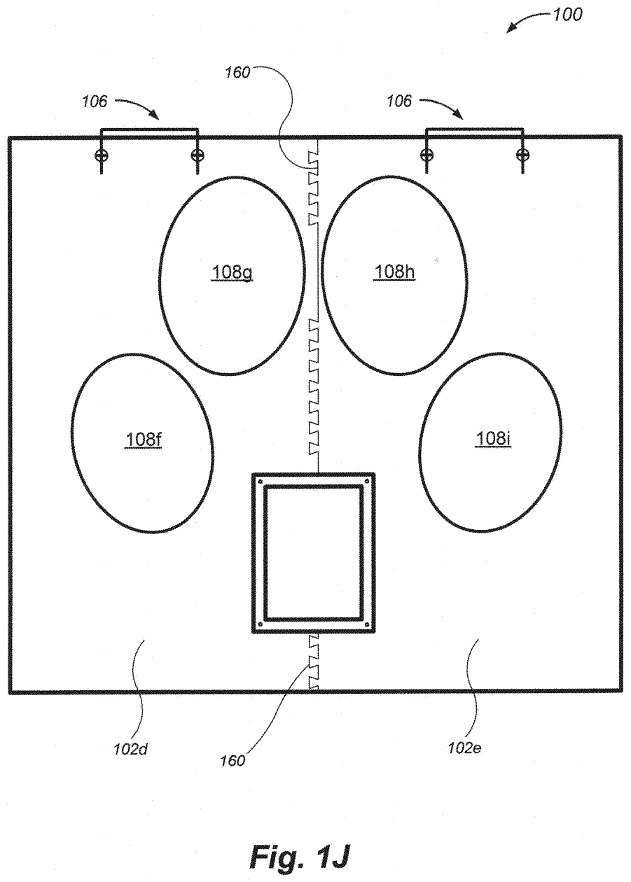

With reference now to FIG. 1A, depicted is an inside facing surface view of a first preferred embodiment of a pet window 100. Panel 102 (e.g. view of panel is from inside of home looking out window) includes a passageway 103, but preferably a pet door 104 is already installed into panel 102 prior to pet window 100 product sale. Pet door 104 may be provided (or partnered) by a third party before or after sale of a pet window 100. Pet door(s) 104 may be anticipated by a pet window 100 design. So, panels 102 may include the passageway 103 cut to specifications for supported pet door(s) 104 if customers install their own pet doors 104. In some pet window 100 embodiments, a pet door 104 is integrated directly with the panel 102 material to eliminate unnecessary pet door 104 parts (e.g. supporting perimeter) as it relates to design efficiencies provided by panels 102 or attachments/layers thereof. In other embodiments, passageway 103 is not pre-cut, and shim block 110 adjacent panel 102 provides a matching door profile thickness suitable for one or more existing pet doors 104, wherein a customer cuts his own passageway 103 aperture to match a selected pet door 104 (e.g. using a utility knife). Markings (i.e. identifying marks to guide a customization) are preferably included on panel 102 and shim block 110 (or on a layer or decoration thereof) for after-market pet door(s) 104 to help a customer in making customizations. Markings may be provided with applied decals, measurement indications, or stencils to apply to a pet window 100 surface. Markings may include lines, marks for lines, of the like, to guide customization cutting. The terminology “passageway” used herein refers to: a) an actual aperture/hole cut through panel 102 from outside surface to opposite outside surface, b) aperture/hole marking(s) on panel 102 for identifying where to cut said aperture/hole, or c) an area of panel 102 destined for said aperture/hole to host the pet door 104.

Markings (i.e. identifying marks to guide a customization as described above) are also provided for customizing the size of a pet window 100, for example to cut bottom, top, or side portions of panel 102 for a vertically or horizontally aligned straight edge to appropriately replace a screen. In pet window 100 embodiments having a shim block 110, shim block 110 may be adhered to panel 102 with an adhesive, firmly adjacent panel 102 by virtue of an installed pet door 104, or may be provided loose for subsequent pet door 104 installation (e.g. pet door itself causes squeezing shim block 110 firmly against panel 102). Of course, shim block 110 may include markings for customization like panel 102, and markings may be provided for positioning shim block 110 adjacent panel 102. Panels 102 may be constructed/manufactured of any rigid material of adequate strength and insulation properties, and not to be limited to foam board, polyethylene foam board, cross linked polyethylene foam board, polystyrene foam board, air-infused closed cell or open cell plastic foam board cut and/or extruded, fiberglass board, carbon infused board, graphite infused board, plastic, or other material, or a combination resin-based layering using a foam board (e.g. a composite foam board) or other material.

Panels 102 may also be constructed/manufactured using fiber-board, fibre-board, hardi-board, plywood, fiber cement board, MDF board (Medium-Density Fibre board), laminate plank, strand board, wall board, wall plank, tile board, white board, composite board, decking board, backer-board, siding panel, Wonderboard®, rigid foam insulation board, high density insulation board, combinations involving thereof, or any other like plank or board. Panel 102, or a layer thereof, may be corrugated, or may contain skeletal support members for extra strength/rigidity (e.g. internal or external slats, strips, battens, struts, embedded material, steel/plastic bars, steel/plastic wire, or the like). Panel 102 is not required to be planar, for example being convex to the outside or oddly shaped, provided the window screen retaining mechanism of the target window being replaced is emulated. Panel 102 is referred to with language “substantially planar” because the outer edge(s) of panel 102 form a substantial plane that is received securely into a window screen track (also adjacent other related window installation surfaces when applicable), regardless of how many insulation layers and options are attached thereof.

The terminology “plastic” used herein refers to any of the wide range of synthetic or semi-synthetic organic compounds that can be molded into solid objects, for example amorphous thermoplastics (ABS, Acrylic, Kydex, Noryl, PETG, Polycarbonate, Polystyrene, Polysulfone, PVC, Radel, Ultem, or the like), semicrystalline thermoplastics (Acetal, HDPE, LDPE, Nylon, PBT, PEEK, PET, Polyupropylene, PPS, PTFE, PVDF, UHMW-PE, or the like), imidized materials (Polyamide-imide, Vespel Polyimide, or the like), and any like plastic, material, composite, foam, mixture, alloy, or combinatory formula thereof. The terminology “material” used herein refers to aluminum, metal, wood, glass, plastic, rubber, fiber, string, cord, strap, paper, cardboard, organic material, inorganic material, synthetic material, or any other suitable substituted material for carrying out forming (e.g. making, molding, printing, extruding, or any other manufacture) of any component/part of this disclosure. Of course, panel 102, or any component (or part) of this disclosure (e.g. has a described Figure number, or is illustrated as a part of a pet window 100), may be manufactured with any material or a composite of materials for appropriate integrity.

Panels 102 thicknesses, for example profile thickness 132 (FIG. 1F), preferably matches thicknesses of replaced screen frames (metal, wood, aluminum, fiberglass, vinyl, etc) such as ¼ inch, 5/16 inch, ⅜ inch, 7/16 inch, ¾ inch, 1 inch, or any other screen frame thickness dimension. For example, panel 102 thickness is to fit properly within the window screen track. However, additional insulation layers may be added to a surface of panel 102 (e.g. outside surface 122) as determined appropriate for a geographical location, thereby having panel 102 fit well with retainer(s) 106 into a window screen track at panel 102 edges (and retainer 106 engagement areas) while much of panel 102 surface exceeds thickness of the replaced window screen.

A panel 102 is water resistant on the outside facing view of pet window 100, and may require a water resistant coating if the material used is not inherently water resistant. In some embodiments, panel 102 is in fact a layered combination of adhered materials or sheet products to accomplish desired insulation and/or strength properties. Panel 102 may also incorporate layers of material on the inside or outside surfaces of panel 102 to accomplish desired insulation (e.g. temperature or water resistance) and/or strength properties. In some embodiments, panels 102 have supporting materials to keep rigidity and planar properties. Panels 102 (and accessory windows 108) may include decorations such as a variety of colors, paint(s), printed designs or scenery, applied glitter, an adornment (e.g. jewelry, trinkets, ornaments, embroidery, garnish, tinsel, embellishment, or the like), photographic overlay printing, artistic printing or painting, engraving, embossing, decals (e.g. FIG. 1E)), or any other aesthetic appearance, for example on one or both surfaces 120 and 122 (FIG. 1F). Decorations preferably enable a theme of the pet window, such as a cat theme, dog theme, named pet theme, police dog theme, farm cat theme, or any theme desired by a customer and presented by the decorations. Panel 102 may also include decoration including a sculpted outside surface 122 for decorative artistic appearances. Inside surface 120 should not contain decorative attributes, or components (i.e. parts), that may interfere with opening or closing a movable window sash adjacent the screen being replaced with pet window 100 (i.e. dimension 136 being appropriate).

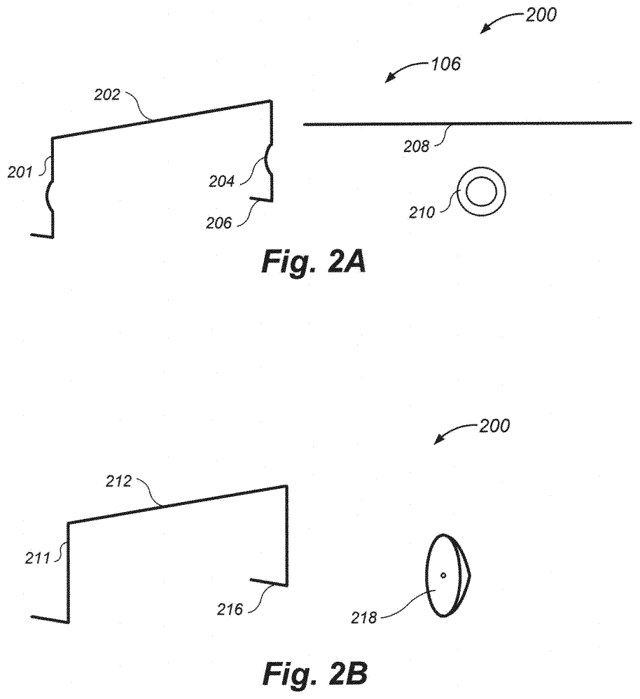

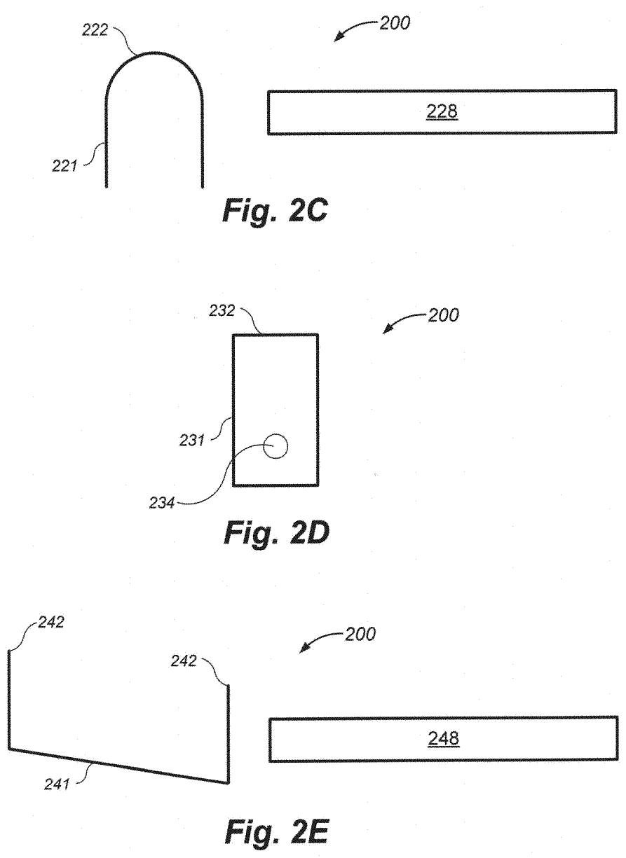

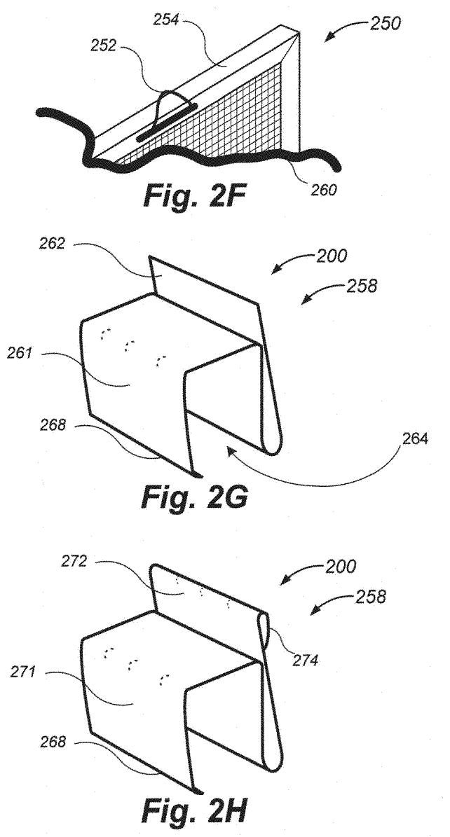

There are one or more panel retainers 106 (FIG. 1A depicts two) to securely retain panel 102 in position (e.g. within the window screen track) like the screen it replaces. Retainer 106 emulates mechanical operation of retaining mechanism(s) of the window screen being replaced. Reinforcement members (e.g. FIG. 2A 210) may be included for being adjacent surface(s) of panel 102 for supporting panel retainer 106 without damaging the surface of panel 102 when in use. In the FIG. 1A embodiment, and as is customary in many home window screen configurations of North Texas, top edge 140 of panel 102 has panel retainers 106 nearby for causing a downward spring action fit with compression (i.e. at least gravity, and preferably with additional downward force exerted) against the bottom window screen track. Those skilled in the art appreciate that when unusual window screens do not use a similar window screen track, panel 102 is designed/integrated with appropriate retainer(s) 106 without departing from the spirit or scope of the disclosure for emulating mechanical operation of retaining mechanism(s) of the window screen being replaced.

Pet window 100 may include one or more accessory windows 108 constructed as part of panel 102. An accessory window 108 requires an applicable aperture through panel 102 for supporting a reasonably transparent, translucent, or see-through material enabling a pet to look inside or outside panel 102 through accessory window 108. Alternatively, a one way mirror may be used for an accessory window 108. In some embodiments, an accessory window 108 may be a perforated, cross-hatched, screened window, or the like. Testing indicates a pet prefers visibility to the opposite side of panel 102 before venturing through pet door 104, and training a pet to use the pet window 100 occurs quickly with good visibility. Many pet doors 104 do not provide clear undistorted visibility. Accessory window(s) 108 solve pet visibility issues when a pet considers entering or leaving a home through pet door 104. An accessory window 108 is preferably made of plastic for light weight, for example polycarbonate, acrylic, Plexiglas, or the like, but may be made with other see-through material. Accessory windows 108 may be of any shape, size, position, or dimension, provided strength of panel 102 being retained properly in a window screen track is not compromised. In some embodiments, accessory windows 108 fortify integrity of panel 102 with how accessory windows 108 are affixed to, or integrated with, panel 102. In some embodiments, panel 102 comprises an outside facing surface and inside facing surface secured against each other with an adhesive for sandwiching accessory window(s) 108 in designated location(s). The FIG. 1A embodiment depicts accessory windows 108 adjacent the outside surface 122 of panel 102 with edges of window accessory cut-outs (apertures in panel 102) accessible at the inside surface 120 of panel 102. Accessory windows 108 not providing good insulation qualities preferably occupy in total a minimized area on a panel 102. An accessory window 108 may be rigid or flexible, and aperture(s) for accessory window(s) 108 may include any shapes, including cut out letters and other objects. A pet window 100 may be an automatically manufactured complete product off an assembly line (e.g. thermoformed, fabricated, and equipped), or packaged as components for assembly. Any combination of features or options may be incorporated for a complete pet window 100 product off a manufacturing assembly/production line.

With reference now to FIG. 1B, depicted is an outside facing surface view of the first preferred embodiment of the pet window 100 of FIG. 1A. Accessory windows 108 are flush against the outside surface of panel 102 and secured thereon with a weather proof perimeter 112, for example weather proof aluminum tape with a single highly adhesive side (and highly weatherproof aluminum opposite side) for securing accessory window 108 outer edges against panel 102. Perimeter 112 holds (i.e. secures, affixes, adheres, couples, bonds, holds, fastens, sticks, grips, clasps, clutches, hugs, or the like) an accessory window 108 in place to panel 102. Shim block 110 is used when panel 102 does not provide enough wall thickness for installation of a pet door 104. An aperture (or hole) of passageway 103 continues through shim block 110 and enables properly hosting installation of pet door 104. Shim block 110 is adjacent panel 102 on the outside surface of panel 102 where there is no concern for interfering with movable window sash operation via dimension 136. Shim block 110 is preferably manufactured/constructed of foam board, polyethylene foam board, cross linked polyethylene foam board, polystyrene foam board, air-infused closed cell or open cell plastic foam board cut and/or extruded, however, any material used to construct a panel 102 embodiment, or layer thereof, may be used.

Panel 102 is inserted into position for replacing a screen by applying upward pressure on panel 102, after guiding the topmost portion of retainer(s) 106 into (or adjacent to) the top window screen track used for the usual window screen retaining mechanism of the target window screen being replaced. Spring action of retainer 106 wanting to remain adjacent panel 102 exerts a downward force of panel 102 against the bottom window screen track when topmost portion(s) 202 (see FIG. 2A) are placed into the top window screen track as described, and panel 102 remains on the outside of the track at top edge 140.

With reference now to FIG. 1C, depicted is an inside facing surface view of a second preferred embodiment of a pet window 100. Accessory windows 108 may be of any configuration, and may themselves have any of the decorations described above (engraving, embossing, decal, etc). One or more pet window 100 attached installation facilitator(s) 114a make it easier for a user to install panel 102 like the screen it replaces. Installation facilitator(s) 114, for example short straps to facilitate upward force during installation, wrap around the bottom edge of panel 102, are attached (i.e. affixed, adhered, coupled, bonded, held, fastened to, stuck to, held to, gripped to, clasped to, clutched to, hugged, riveted, bolted, soldered, or the like) to panel 102 (e.g. with an adhesive), and provide loose strap ends (handles) for pulling upward. See FIG. 1F.

With reference now to FIG. 1D, depicted is an outside facing surface view of a third preferred embodiment of a pet window 100. Accessory windows 108 in a paw configuration facilitate a cat theme. Shim block 110 is shaped in a paw configuration. Shim block 110 may be decorative having texture and/or sculpted with outer surface shape for a more artistic effect and may be adorned (decorated) with color, print, paint, or any decorative characteristics/attributes described above like panel 102. Many preferred embodiments of shim block 110 comprise a medium to high density polystyrene foam (Styrofoam®).

The FIG. 1D pet window 100 also has an option of solar power through use of solar panels 142 attached (i.e. affixed, adhered (e.g. double sided sticky tape), coupled, bonded, held, fastened to, stuck to, gripped, clasped, clutched, hugged, riveted, bolted, soldered, or the like) to the top left and right sides (e.g. with a double sided adhesive) for powering a variety of electric appliances. Any option (device, system, apparatus, gauge, light, etc) to panel 102 which consumes electricity (AC or DC) is considered an electric appliance. One or more solar panels 142 may be affixed to the outside facing surface of panel 102, for example to power at least LED lights 144. Many LED lighting configurations may be incorporated to panel 102 for aesthetic or other reasons: patterns, spelling of character(s), different colors/brightness/dimensions/appearances/blinking, etc. Further, solar panels 142 are compression fit hinged at their top edge for facing solar cells up to the sky at a desired angle (i.e. adjusting) on the outside of a window (i.e. support backing of solar panel is affixed to panel 102 and the solar cell panel is hinged to the backing). Other embodiments may incorporate solar panel adjustability for angling solar panels 142 in side to side directions, for example by using a compression fit ball and socket attachment of a solar panel 142 to panel 102 wherein the ball and socket housing is attached (i.e. affixed, adhered, coupled, bonded, held, fastened to, stuck to, gripped, clasped, clutched, hugged, riveted, bolted, soldered, or the like) to panel 102. While it is recommended that pet window 100 options, for example solar panels 142, be located at the top portions of panel 102 to avoid interactions with a pet, placement may be anywhere. Another embodiment provides solar panel(s) 142 to the customer for convenient locating near panel 102 (rather than on panel 102), so that wiring from the solar panel(s) 142 can be fed through a small well-located hole in panel 102 leading to the inside surface of pet window 100. Panel 102 may provide an exterior awning attachment support 150 (e.g. Velcro attachment 1 of 2). Of course, solar panels 142 may be very thin rigid or flexible solar cell panels, a solar panel coating or layer, and in a variety of shapes and sizes, attached to panel 102.

With reference now to FIG. 1E, depicted is an inside facing surface view of a fourth preferred embodiment of a pet window 100, for replacing a small window screen. One or more installation facilitator(s) 114b attached to panel 102 make it easier for a user to install panel 102 like the screen it replaces. Installation facilitator(s) 114b depict another facilitator embodiment. Cords facilitate upward force during installation by being inserted through small holes in panel 102 with a large knot in the cord on the outside surface of panel 102 for exerting force against outside surface 122 of panel 102 when a user pulls the cords from inside with upward force. The knot on the outside of panel 102 prevents the cord from slipping through panel 102 when used. Washers (e.g. component/part 210) may be provided to the outside surface of panel 102 to prevent damage to panel 102 when pulling cords up from the inside surface of panel 102. Those skilled in the art appreciate a variety of designs to accomplish an installation facilitator 114, depending on a particular screen design, without departing from the spirit or scope of the disclosure.

While accessory windows 108 (i.e. windows subordinate to panel 102) have been presented in one embodiment as being taped to the outside of panel 102, there are many embodiments for attaching (i.e. affixing, adhering, coupling, bonding, holding, fastening, sticking, gripping, clasping, clutching, hugging, or the like) accessory windows 108 to panel 102. An accessory window 108 may be taped around its perimeter to the inside of panel 108, or glued to panel 102 (either side) with a neat bead of glue around its perimeter. A tape perimeter may be used to simply hide the bead of glue and provide aesthetic edges. An accessory window 108 may be riveted, bolted, or attached (e.g. with hardware of plastic or other material) to panel 102 wherein a bead of caulk may be used to seal accessory window edges against panel 102. In another embodiment, panel 102 is of sufficient thickness to provide, around the aperture in panel 102, a recessed edge for flush receipt of accessory window 108 on one side of panel 102. The recessed edge outer dimensions match outer dimensions of an accessory window 108 wherein accessory window 108 lies adjacent the recessed area within panel 102. A bead of glue, tape, or caulk may then be used to seal accessory window 108 into the recessed area for a tight fit. Alternatively, picture frame staples, perimeter retainers, pins or nails may be used in places of the recessed edge to hold the accessory window 108 into place. Those skilled in the art appreciate a variety of designs to accomplish an accessory window 108 preventing weather leakage without departing from the spirit or scope of the disclosure.

With reference now to FIG. 1F, depicted is a profile illustration of a preferred embodiment of a pet window 100. A basic pet window 100 is depicted (i.e. no profiles of options). Panel thickness 132 and shim block thickness 134 make up (when adjacent each other) pet door 104 specified installation wall thickness 130. The force of an installed pet door 104 will keep panel 102 and shim block 110 tightly adjacent (e.g. no glue required). An adhesive may or may not be used in advance of pet door 104 installation, for example when customers install their own pet door 104. Panel 102 and shim block 110 have matching passageways 103 for accepting installation of pet door 104, such as passageway 103a (e.g. hole/aperture) in panel 102 adjacent the home inside facing surface 120 of pet window 100 and passageway 103b (e.g. hole/aperture) adjacent the outside facing surface 122 of shim block 110. Pet door 104 is dimensioned with a minimal presence at the inside facing surface 120 of panel 102 to allow proper window operation of a movable window sash adjacent the screen being replaced by panel 102. The Ideal Pet door 104 mentioned above meets this criterion with a small dimension 136 at the home inside surface 120. Dimension 136 is the profile distance between: #1) any portion of pet window 100 closest the moveable window sash; and #2) any portion of the moveable window sash closest to #1. Many windows have about 1 inch of profile space between the window sash hardware and the screen position via neighboring window tracks. Dimension 136 is to be less than the profile space (e.g. 1 inch) between the window sash hardware at the home inside and the window screen position. The overall profile dimension 138 of pet door 104 is not important provided inner dimension 136 permits proper adjacent window sash opening and closing while pet window 100 is installed. Panel 102 may include a recessed cut out on inside surface 120 for accepting the pet door 104 in such a way as to eliminate or reduce a dimension 136. A panel 102 recessed cut out may also be present for shim block 110, for example at the outside surface 122 to lessen profile dimension 130 for proper wall thickness 130 of a pet door 104. Similarly, shim block 110 may have a recessed cutout at outside surface 122 to better fit a pet door 104.

An installation tool 116 may be provided rather than an installation facilitator 114 attached to panel 102 (however, installation tool 116 is also referred to as an installation facilitator). Installation tool 116 has a thin profile 118 thickness equal to, or very slightly greater than a window screen track edge height from the window screen track bottom. Profile 118 may be curved rather than straight. Tool 116 is laid substantially flat about the middle of the window screen track adjacent to the outside of the bottom window screen track for sliding (installing) the bottom edge of panel 102 inward into the track, after positioning of retainer(s) 106. Tool 116 conveniently provides upward force upon sliding the panel 102 bottom edge into the window screen track. The bottom edge of panel 102 will require prying up with a tool before removal of pet window 100 from the window screen track. Installation tool 116 is used for pet windows that are planned for permanent install, or installs where customers are not concerned with removal. Pet windows 100 may be permanent while the associated window sash opens and closes normally. A removal tool, such as a wide putty knife (or spackling knife), will prevent damage to the bottom edge of panel 102 by spreading upward force over a larger bottom edge of panel 102 when removing pet window 100 from the window screen track. Pushing up at the pet door 104, without force causing damage to pet window 100, will provide upward force as well (with or without a removal tool).

With reference now to FIG. 1G, depicted is another profile illustration of a preferred embodiment of a pet window 100. A basic pet window 100 is depicted (i.e. no profiles of options). Panel thickness 132 itself makes up pet door 104 specified installation wall thickness 130. No shim block 110 is required. Panel 102 may or may not have recessed cutouts, or recessed indentations, for pet door 104 at inside surface 120 and/or outside surface 122. Panel 102 has a passageway 103 for accepting installation of pet door 104. Pet door 104 is dimensioned with a minimal presence at the inside facing surface 120 of panel 102 to allow proper window operation of a movable window sash adjacent the screen being replaced by panel 102. The Ideal Pet door 104 mentioned above meets this criterion with a small dimension 136 at the home inside surface 120 (e.g. without a recessed cutout on panel 102 at inside surface 120). The overall profile dimension 138 of pet door 104 is not important provided inner dimension 136 permits proper adjacent window sash opening and closing while pet window 100 is installed.

Panel 102 is thick enough to accommodate the pet door 104, for example when the bottom window screen track is wide enough to accept thickness 130. Alternatively, the bottom edge 162 need not be flat (i.e. perpendicular to panel 102 surface) for being received into a window screen track. For example, bottom edge 162 may include enough of a perpendicular surface, or a pointed edge adjacent inside surface 120 along the entire bottom edge 162, for being received into the window screen track while a tapered bottom edge 164 exists therefrom to outside surface 122 for clearing the entire length of the outside of the bottom window screen track (i.e. bottom right corner of panel 102 depicted in FIG. 1G is removed with installation facilitator(s) 114a running adjacent new tapered bottom edge 164 at panel 102 bottom and substantially up outside surface 122 above intersection of tapered bottom edge 164 to outside surface 122). This embodiment enables the bottom edge 162 to be received securely into a window screen track with the adjoining bottom edge 164 exiting out of the window screen track. In another embodiment, bottom edge 162 (e.g. perpendicular entirely to panel 102 surface 120/122) is received into a window screen track while another bottom edge 164 (e.g. perpendicular entirely to panel 102 surface 120/122) is parallel to bottom edge 162, but at a higher elevation to remain out of the window screen track. (e.g. corner identified by bottom edge 164 is a rectangular shaped profile removed adjacent and along the entire bottom edges 162 and 164). In another embodiment, bottom edge 162 (e.g. perpendicular entirely to panel 102 surface 120/122) is received into a window screen track adapter, which is turn adapts the thickness 130 of panel 102 at bottom edge 162 for being received securely into a window screen track.

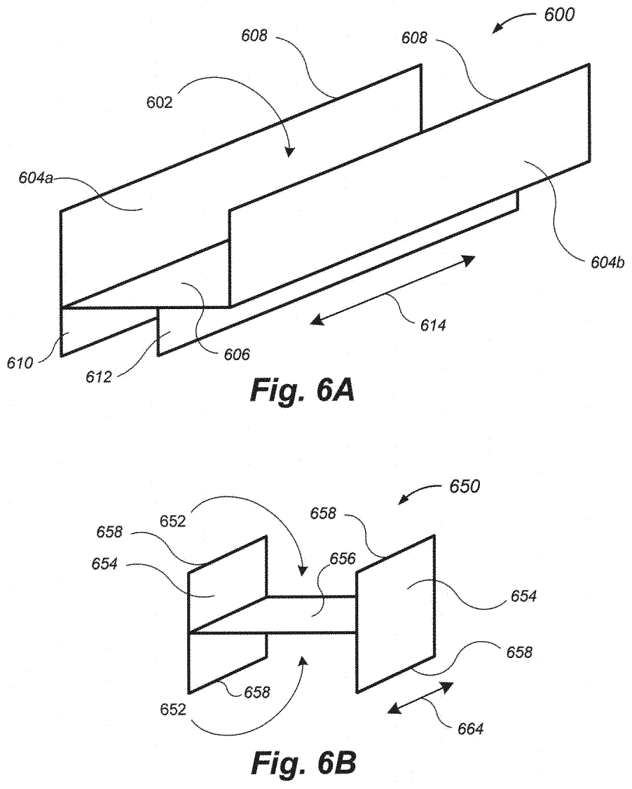

With reference now to FIG. 6A, depicted is a useful pet window component referred to as a window screen track adapter 600. Track adapter 600 adapts a thicker panel (or sub-panel) 102 to a window screen track, for example when the thickness of panel (or sub-panel) 102 exceeds fitting securely into the window screen track. Track adapter 600 is preferably constructed of plastic, but may be constructed of any material. Preferably, bottom edge 162 is inserted for the entire horizontal length of panel 102 into channel 602 between adapter side 604a and adapter side 604b. Adapter side 604a will be adjacent inside surface 120 and adapter side 604b will be adjacent outside surface 122 for sandwiching panel 102 (i.e. or layer(s) thereof). The height of sides 604, and width of bottom 606, will be adequate for firmly grasping the bottom of panel 102, preferably without falling off after installation to panel 102. The top edges 608 may have an inward bend (not shown) as depicted by angled flange 268 for firmly holding panel 102 into channel 602. In some embodiments, the angled flange of top edges 608 cause installation of adapter 600 to be best performed by sliding it parallel to the bottom edge 162 after the panel 102 already contacts bottom 606 at one end of adapter 600. Once installed, a footing 610 of adapter 600 is placed into the window screen track. Thus, a very thick panel 102 can be adapted to any width window screen track. While a tight fitting of panel 102 into channel 602 facilitates stability, an optional leg 612 may be included for contacting an outside window installation surface at the outside of the window screen track for extra stability of panel 102 held into the window screen track by adapter 600. In some embodiments, the horizontal length 614 of adapter 600 need not match the horizontal length of panel 102, for example by having one or more adapters 600 installed to the bottom of panel 102. In such embodiments, the vertical height of footing 610 should match (or be slightly less than) the height of the window screen track so as to prevent air space gaps at the window screen track below panel 102. Installation facilitator(s) 114a may be as shown in FIG. 1G prior to installation of adapter 600, may be alternatively attached to the bottom of adapter 600, or may be integrated appropriately with adapter 600.

In some embodiments, side 604a may be reasonably flexible, or may be affixed to a reasonably flexible top edge 608 that can be manipulated at inside surface 120 for installation. In another embodiment, side 604a already contains affixed installation facilitator(s) 114a. Leg 612 need not be a continuous length of material for the horizontal length 614. In some embodiments, leg 612 is a plurality of spaced legs 612, or one or more legs 612, for example in a “post” type of leg configuration, for providing stability. Those skilled in the art appreciate a variety of designs to accomplish an adapter 600 preventing weather leakage at a window screen track, and/or providing installation facilitator functionality, and/or providing additional installation pet window 100 stability, without departing from the spirit or scope of the disclosure.

In some embodiments, recesses (i.e. recessed cutouts, or recessed indentations) are provided to inside surface 120 and/or outside surface 122 to accommodate pet door 104 so that overall profile dimension 138 of pet door 104 matches, or is less than, thickness 132. Weather-proof pet windows 100 may also include panel(s) 102 thicknesses exceeding the overall dimension 138 of pet door 104. Similarly, recesses (i.e. recessed cutouts, or recessed indentations) are provided to inside surface 120 and/or outside surface 122 to accommodate pet door 104 so that overall profile dimension 138 of pet door 104 matches, or is less than, thickness 130. In most practical examples, a recess is provided at inside surface 120 to accommodate many various pet doors 104 that would otherwise cause a dimension 136 unsuitable for proper window sash operation. The recess at inside surface 120 enables any protruding portion of pet door 104, upon installation, to be tucked into panel 102 (or sub-panels 102) for an eliminated or minimized dimension 136.

With reference now to FIG. 1H, depicted is a panel componentization illustration of a preferred embodiment of a pet window 100. Panel componentization refers to pet window 100 requiring assembly of a panel 102 with a plurality of panel 102 parts referred to as sub-panels 102. “Panels” 102 and “sub-panels” 102 terminologies may be used interchangeably for a plurality of substantially planar panels combined to make an overall substantially planar panel 102. For example, panel 102 is comprised of sub-panels (components) 102a, 102b and 102c which are vertically adjacent each other at seams 160. A sub-panel 102 may have any features (i.e. options, attributes, characteristics, or the like) described herein for a panel 102. The only difference is a sub-panel 102 is one of a plurality of sub-panel components for forming a panel 102. Thus, pet window 100 is formed with a combined plurality of substantially planar panels 102 (e.g. a combination, coupling, joining, assemblage, construction, grouping, arrangement, or the like) wherein each is designed to contribute to the overall pet window 100. The plurality of substantially planar panels 102 (or alternatively sub-panels 102) is a combinative apparatus having the plurality or panels 102 arranged adjacent each other, and when combined, form an apparatus with dimensions sized for replacing a window screen adjacent a movable window sash. The substantially planar sub-panels 102 fit together like a puzzle to construct an overall panel 102, as disclosed herein, for pet window 100. In some preferred embodiments, seams 160 are intentionally fitted like jigsaw puzzle pieces that, when assembled, stay together tightly as a plane based on interlocking of adjacent sub-panel male and female matched connections, exactly as a jigsaw puzzle is assembled for maintaining tight two dimensional engagement of the puzzle pieces when assembled to see the complete picture presented to the jigsaw puzzle.

The combinative apparatus makes the pet window 100 product easier to ship and mail to customers, for example by website or mail order, by reducing part sizes (of sub-panel 102 components) assembled to complete a pet window 100. In preferred embodiments, seams 160 are designed for a firm engagement of adjacent sub-panel 102 edges, for example, panel 102b has at both vertical seams 160 a female “V” shaped profile looking down vertically from top edge 140 while the adjacent edges of panels 102a and 102c have male “V” shaped profiles looking down vertically from top edge 140. This enables a firm horizontal mating engagement of panels 102 in FIG. 1H, although there is little to provide horizontal compression keeping the sub-panels 102 together tightly unless a mating engagement (like jigsaw puzzle pieces, dove tail ends, or the like) is incorporated. In various embodiments, sub-panels 102 seams 160 have various matching male and female design profiles for being reasonably retained in position to each other in a mating engagement (i.e. identically to mating engagement of jigsaw puzzle pieces, dove tailed ends, or the like). Thus, mating engagements of adjacent sub-panels 102 are performed for maintaining sub-panels 102 in a horizontal adjacent position as well as keeping surfaces 120 and 122 substantially planar at seams 160. However, not all subpanels 102 require being matched in thicknesses. For example, panels 102a and 102c may be substantially thinner than panel 102b which is sized to match a pet door 104. In some embodiments, an adhesive may be applied for further affixing sub-panels 102 together. Adapter 600 is very useful for not only adapting pet window 100 to any window screen track, but also for firmly holding sub-panels 102 together at the bottom edge 162. Some embodiments of adapters 600 accommodate different sub-panel 102 thicknesses for some pet window 100 designs (e.g. varying width bottoms 606 and/or varying height sides 604 as appropriate for a length 614).

Sub-panel retainer components, referred to as panel edge reinforcements, may be provided for a pet window 100 product, for example to keep sub-panels 102 firmly together. A panel edge reinforcement is essentially an adapter 600 without footing(s) 610 and leg(s) 612 as described above in comprising a channel 602 for receiving a plurality of sub-panels 102 between sides 604 and top edges 608, adjacent bottom 606, preferably for the horizontal length 614 accommodating all sub-panels 102. Such panel edge reinforcements are essentially an elongated rectangular “U” profile and may also be placed at top edge 140, or pet window 100 sides (e.g. when sub-panels 102 seams 160 extend to a side of pet window 100 such as vertically stacked sub-panels 102). Use of panel edge reinforcement at top edge 140 will enable only requiring one or two retainers 106 instead of three as shown.

The preferred pet window 100 product consists of a barcode marked package containing installation instructions, advertisement collateral (e.g. packaging header with title “MyLow Pet Window™” advertisement picture facilitating immediate product understanding), and any of the embodiment pet window 100 components described herein (parts, components, Fig. references, hardware, options, features, modified parts/components, etc). One minimal embodiment product includes a set of components, such as a plurality of sub-panels 102 (or a single customizable panel 102), an optional shim block 110, at least one track adapter 600, at least one panel edge reinforcement, at least one retainer 106 (and components/parts thereof), at least one installation facilitator 114, and weather stripping for weather-proofing the perimeter of the pet window 100 installation. Panel 102 or sub-panels 102 (individually or as assembled) may or may not include any of the features (i.e. options, attributes, characteristics, or the like) disclosed herein.

With reference now to FIG. 6B, depicted is a useful pet window component referred to as a seam binder 650. Seam binder 650 binds (i.e. secures, affixes, adheres, couples, bonds, holds, fastens, sticks, grips, clasps, clutches, hugs, or the like) sub-panel 102 edges together and is preferably constructed of plastic, but may be constructed of any material. Seam binder 650 is an elongated “H” profile for receiving into channels 652 sub-panel 102 adjacent edges against bottom 656 so that sub-panels 102 are sandwiched between sides 654. The height of sides 654, and width of bottom 656, will be adequate for firmly grasping the edges of sub-panels 102. Outermost edges 658 may have an inward bend (not shown) as depicted by angled flange 268 for firmly holding sub-panels 102 into channel 652. In some embodiments, the angled flange of outermost edges 658 cause installation best performed by sliding it parallel to the sub-panel 102 edge after the sub-panel 102 already contacts bottom 656 at one end of binder 650. In some embodiments, the horizontal length 664 need not match the vertical length of sub-panel 102 seam 160 edges, for example by having one or more binders 650 installed at specific seam 160 places. Some binder 650 embodiments are perforated, adorned, constructed with patterns, or decoratively colored, shaped, sized, or architected to contribute to decorative aspects of a pet window 100. When adjacent sub-panels 102 do not have identical thicknesses, opposite channels 652 have different width dimensions to accommodate the different dimensions. Binders 650 are referred to as panel 102 connections. Panel 102 connections hold sub-panels 102 together and may take on a variety of embodiments. In some embodiments, seams 160 are minimized in tightly holding together sub-panel 102 edges by use of panel 102 connections such as edge snaps, bolted overlays (like overlays 228 and 248), decorative tape, staples, pins, or other embodiment panel connection hardware of a suitable plastic or material. Those skilled in the art appreciate a variety of sub-panel 102 binder solutions to accomplish keeping sub-panels 102 tightly together, without departing from the spirit or scope of the disclosure.

Alternatively, an adapter 600 may comprise only two overlays (i.e. sides 604 (like overlays 228 and 248)) of a suitable material having matching holes for receiving bolts that sandwich the two substantially rigid overlays together over panel 102 wherein side 604a is taller (having an extending footer 610 for being received into the window screen track) than the overlay for side 604b at outside surface 122. Similarly, a binder 650 may include only two substantially rigid overlays (i.e. sides 654) of a suitable material having matching holes for receiving bolts that sandwich the two overlays together over panel 102 at appropriate seam 160 positions. Similarly, a panel edge reinforcement may include only two substantially rigid overlays (i.e. sides 604 or sides 654 (like overlays 228 and 248)) of a suitable material having matching holes for receiving bolts that sandwich the two overlays together over panel 102 at appropriate outer edge(s).

With reference now to FIG. 1I, depicted is another panel componentization illustration of a preferred embodiment of a pet window 100. All of the descriptions described above for FIG. 1H apply to FIG. 1I including seams 160 and features thereof (e.g. profiles, adhesives, binders, reinforcements, adapters, or other options for holding together sub-panel 102 edges) pertain to FIG. 1I. However, seams 160 need not be vertical. In fact, a seam 160 may be vertical, horizontal, diagonal, shaped to accommodate a pet window 100 design as depicted in FIG. 1I, or as is applicable to a particular pet window 100 for convenient product size mailing. Irregular seams (i.e. not straight lines like FIG. 1H) such as those of FIG. 1I may prescribe an irregular matching binder 650 as is appropriate to follow a seam 160 contour. In some pet window 100 embodiments, a pet window 100 product includes a single panel 102 as depicted in FIG. 1E with a plurality of vertical sub-panels 102 (e.g. referred to as slats) to be installed at either side wherein the horizontal measurement of a slat is planned for acclimating the FIG. 1E panel 102 to a variety of window screen horizontal track widths and sizes when a certain number of slats are in use. For example, a FIG. 1E embodiment (according to the variety of embodiments discussed throughout this disclosure) may include 1 slat on each side, two slats on each side, three slats on each side, etc. Each slat (i.e. a sub-panel 102) may simply be a substantially planar panel without any options or features thereon wherein panel edge reinforcement spans the entire top edge 140 of all sub-panels 102 and an adapter 600 spans the entire bottom edge 162 for providing integrity as a single overall substantially planar panel 102. Installation facilitators 114b can be inserted through complementary holes through sides 604 of adapter 600. In any case, sub-panels 102 need not match exactly in (e.g. adjacent) dimensions (e.g. profile thickness), construction material(s) used, appearance, or any other characteristic, provided desired pet window 100 functionality is accomplished.

Optimally, seams 160 run reasonably vertically from top to bottom to leverage downward force (gravity with or without spring) exerted in a pet window 100 for North Texas window screens. However, depending on a particular window screen design, direction of force(s) for those installations and panel retainers being used, seam(s) 160 are preferably architected with sub-panel 102 integrity in mind. A seam 160 may intersect pet door 104 (e.g. one seam 160 running vertically down pet door 104 middle to separate two mirror image sub-panel 102 half components), an accessory window, or any other option, feature, or component of a pet window 100. Seams 160 need not be symmetrical. Seams 160 may define a jigsaw puzzle of sub-panels 102 pieces to assemble in forming a pet window 100 substantially planar panel 102. Use of panel edge reinforcement at top edge 140 can minimize retainer(s) 106 while providing reinforcement, and an adapter 600 used at bottom edge 162 can minimize or replace installation facilitator(s) 114. Of course, adhesive(s) may be a pet window 100 product included component used for securing binders 650, adapters 600, or panel edge reinforcements to sub-panels 102.

With reference now to FIG. 1J, depicted is another panel componentization illustration of a preferred embodiment of a pet window 100. All of the descriptions described above for FIG. 1H and FIG. 1I including seams 160 and features thereof (e.g. profiles, adhesives, binders, reinforcements, adapters, or other options for holding together sub-panel 102 edges) pertain to FIG. 1J. However, depicted is a single seam 160 providing a mating engagement between sub-panel 102d and sub-panel 102e. The mating engagement comprises male peninsulas and matching adjacent female sockets for receiving the peninsulas so as to tightly hold sub-panels 102d and 102e together. In FIG. 1J, the mating engagement defining seam 160 includes male peninsulas that are dove tailed ends and adjacent female sockets matching the shape of the dove tailed ends. Similarly, the mating engagement may define seam 160 including male peninsulas that are jigsaw puzzle protrusions and adjacent female jigsaw sockets matching the shape of the jigsaw puzzle protrusions. One or more panel componentization mating engagements may be implemented, and of various designs and dimensions, to accomplish sub-panels 102 remaining in tightly coupled condition for the overall substantially planar panel 102.

FIGS. 2A through 2H depict illustrations for discussing panel retainers 200 (e.g. retainer 106). Retainer 106 embodiments are not to be limited to retainer 200 examples presented. With reference to FIG. 2A, panel retainer 106 (hereinafter referred to as panel retainer 200) was exemplified in previous figures and consists of at least a panel retainer body 201 and panel retainer bar 208, each preferably manufactured of a 12 to 20 gauge galvanized spring steel wire, depending on construction and weight of pet window 100. Retainer 200 (106) of FIG. 2A emulates the common window screen retainer for North Texas depicted in FIG. 2F. While panel retainer 200 (106) utilizes similar gauge wire, the topmost portion 202 is elongated for a far more secure fit (i.e. improved fit) of pet window 100 into the window screen upper (more contact) and lower (more downward pressure) tracks. Knee holes in panel 102: a) receive knee 204; b) are located equidistantly from top edge 140 with topmost portion 202 at a slightly higher elevation of topmost edge 140 as shown in previous Figures; c) are spaced from panel 102 sides for symmetry in placing one or more retainers 200 (106); d) may include a washer 210 at the panel 102 inside surface 120 and/or outside surface 122 to prevent damage to panel 102 when retainer 200 (106) is used; and e) accommodate knee 204 so that knee 204 is sunken (i.e. recessed, dipped, depressed, settled, or the like) into the hole wherein bar 208 secures body 201 with retention force against panel 102 having bar 208 installed on the opposite side of panel 102. Feet 206 are preferably pressed into panel 102 foam board embodiments to enable a reasonable vertically fixed position of retainer 200 (106) to panel 102 (marks may be provided on panel 102, and in some embodiments marks are provided for knee holes to be punched or drilled by the customer after sale of pet window 100). In some panel 102 material, laminate, or layered embodiments, very small holes are present to accommodate tightly fitting feet 206 which are respectively positioned below each knee hole (also provided in panel 102). Any of retainer 200 (106) components/parts (e.g. 201, 208, 210) may be of any dimension and suitable material. A hand tool may be used to press knee 204 firmly into a knee hole before sliding bar 208 through the knee on the opposite side of panel 102. Washers 210, if used for a particular panel 102, are preferably readily available metal or plastic washers (of any size or shape) for protecting a surface of panel 102, but may include any size, shape, or material to accomplish protecting panel 102 from damage. Prominence of knee 204 dimensions is designed in accordance with thickness 132, and washers 210 if applicable. Retainer 200 (106) operates in a similar, but superior/improved, manner to the mechanism of the window screen being replaced (e.g. FIG. 2F).

Bars 208 may have positioned bends: a) to facilitate sliding bars 208 through knees 204; and b) for subsequently finding a locked position. The panel 102 surface area adjacent bar 208 may also have strategically placed depressions, nubs, engravings, embossing, attachments, or other features for facilitating bar 208 installation, as well as holding bars 208 in place without ability to slide from position. Bar 208 itself further provides a convenient grasp for fastening a corner of an exterior awning 500 (e.g. awning material grasped between bar 208 and panel 102), or fastener end (e.g. hook or tag) of an awning grasped between bar 208 and panel 102 (e.g. two retainers 106 support upper portion of a fabric or rigid exterior awning 500). Alternate embodiments of bar 208 include a piece of similar wire or plastic in the shape of a C, J, U, or the like, referred to as a panel retainer hook (not shown). Two panel retainer hooks are inserted through complementary designed knees 204 on the opposite side of panel retainer 102 for keeping body 201 in place, and the hooks may enable holding in place exterior awning 500. Such panel retainer hooks may include a grasper as disclosed in “Product, System, Method, Apparatus, And Article Of Manufacture For Shower Liner Stay” (Ser. No. 15/922,870) for grasping an exterior awning upper portion to maintain the awning in position (e.g. magnetically grasped, etc). In other embodiments, bar 208 is two bars 208, one for each knee 204.

With reference to FIG. 2B, panel retainer 200 consists of at least a panel retainer body 211 preferably manufactured of a 12 to 20 gauge galvanized spring steel wire depending on construction and weight of pet window 100, and panel retainer cap 218 preferably constructed of plastic. Retainer 200 of FIG. 2B emulates the common window screen retainer for North Texas depicted in FIG. 2F. While retainer 200 utilizes similar gauge wire, the topmost portion 212 is elongated for an improved fit of pet window 100 into the window screen upper (more contact) and lower (more downward pressure) tracks. Knee holes in panel 102 are not required because feet 216 are elongated to protrude (i.e. project, overhang, stick out, or the like) on the opposite side of panel 102 for body 211 being retained with strength adjacent panel 102 by caps 218. Similarly to FIG. 2A, retainers 200 of FIG. 2B are: a) located equidistantly from top edge 140 with topmost portion 212 at a slightly higher elevation of topmost edge 140 as shown in previous Figures; b) spaced from panel 102 sides for symmetry in placing one or more retainers 200; and c) may include a washer 210 at a panel 102 surface to prevent damage to panel 102. Feet 216 are inserted into the center of caps 218 for securing body 211 tightly against panel 102 by having caps 218 installed on the opposite side of panel 102. Feet 216 are preferably pressed into panel 102 foam board embodiments (marks may be provided on panel 102). In some panel 102 material, laminate, or layered embodiments, very small holes are present to accommodate tightly fitting feet 216. Any of retainer 200 components/parts (e.g. 211, 218) may be of any suitable material. Washers 210, if used for a particular panel 102, are as described above for protecting a surface of panel 102. Feet 216 may include bend(s) and/or texture to receive caps 218 for preventing slippage. Caps 218 may include feet retainer means therein. Feet 216 may extend through caps 218 for being bent with a tool upon exit of caps 218 to be secured tightly. In other embodiments, caps 218 have a variety of decorative appearances, shapes, sizes, and architectures for a secure engagement of feet 216. Retainer 200 operates in a similar manner to the mechanism of the window screen being replaced (e.g. FIG. 2F).

With reference to FIG. 2C, panel retainer 200 consists of at least a panel retainer body 221 preferably manufactured of a 12 to 20 gauge galvanized spring steel wire depending on construction and weight of pet window 100, and panel retainer overlay 228 preferably constructed of metal, plastic, or a highly adhesive heavy rigid tape. Alternatively, the topmost portion 222 curve may be used for topmost portions 202, 212, or for other panel retainers 200. Component/part 221 may have an elongated flat top like topmost portions 202 and 212. While retainer 200 utilizes similar gauge wire, the topmost portion 222 is slightly more elongated in the top window screen track for an improved fit. No holes in panel 102 are required to accommodate panel retainer 200. Similarly to FIG. 2A, retainers 200 of FIG. 2C are: a) located equidistantly from top edge 140 with topmost portion 222 at a slightly higher elevation of topmost edge 140; and b) spaced from panel 102 sides for symmetry in placing one or more retainers 200. Overlay 228 is attached (i.e. affixed, adhered, coupled, bonded, held, fastened to, stuck to, gripped, clasped, clutched, hugged, riveted, bolted, soldered, or the like) to panel 102 on the same side of panel 102 as body 221 for keeping body 221 flush against panel 102 except during spring action when pet window 100 is installed. Overlay 228 is attached to panel 102 for keeping body 221 in place, so attachments of overlay 228 to panel 102 may directly involve body 221 (e.g. if heavy rigid tape not used). In some panel 102 material, laminate, or layered embodiments, the bottom ends of body 221 are pressed into top edge 140 (i.e. overlay 228 at one or both sides of panel 102 only if reinforcement required for damage-free operation). Any of retainer 200 components/parts (e.g. 221, 228) may be of any suitable material. Overlay 228 may have a variety of decorative appearances, shapes, sizes, and architectures for a secure engagement of body 221 to panel 102. Retainer 200 operates in a similar manner to the mechanism of the window screen being replaced.

With reference to FIG. 2D, panel retainer 200 consists of at least a panel retainer body 231 preferably manufactured of a thin spring steel plate, or flexible plastic plate, having a hole therein for accepting a bolt, rivet, or other fastener. Component/part 231 may have a flat topmost portion 232 as shown, curved topmost portion 222, or shaped topmost portion 232. Topmost portion 232 is elongated in the top window screen track for a more secure fit. A single hole is required in panel 102 to accommodate a panel retainer 200. Similarly to FIG. 2A, retainers 200 of FIG. 2D are: a) located equidistantly from top edge 140 with topmost portion 232 at a slightly higher elevation of topmost edge 140; and b) spaced from panel 102 sides for symmetry in placing one or more retainers 200. Washers 210 may be used at either side of panel 102 to accommodate fastening body 231 to panel 102 without damage during operation. Washer 210 may be of a lock washer variety. Alternatively, a lock nut may be used with a bolt (e.g. metal or plastic fasteners). When body 231 is fastened to panel 102, similar spring action at the top (232) of body 231 is used to firmly seat panel 102 into the window screen track like other embodiments heretofore discussed. Body 231 may have a variety of decorative appearances, shapes, and sizes. Body 231 may also be used at other edges of a panel 102 for other window screen replacement designs.

With reference to FIG. 2E, panel retainer 200 consists of at least a panel retainer body 241 preferably manufactured of a 12 to 20 gauge galvanized spring steel wire depending on construction and weight of pet window 100, and panel retainer overlay 248 preferably constructed of metal, plastic, or a highly adhesive heavy rigid tape. Topmost portion 242 post ends are placed in the top window screen track for spring action. No holes in panel 102 are required to accommodate panel retainer 200. Similarly to FIG. 2A, retainers 200 of FIG. 2E are: a) located equidistantly from top edge 140 with topmost portion 242 post ends at a slightly higher elevation of topmost edge 140; and b) spaced from panel 102 sides for symmetry in placing one or more retainers 200. Overlay 248 is attached (i.e. affixed, adhered, coupled, bonded, held, fastened to, stuck to, gripped, clasped, clutched, hugged, riveted, bolted, soldered, or the like) to panel 102 on the same side of panel 102 as body 241 for keeping body 241 against panel 102 except for spring action when installing. The bottom bar of body 241 provides reinforced strength adjacent panel 102, and firm positioning of topmost portions 242 post ends into the top window screen track, for less reliance on overlay 248 providing all support. Overlay 248 is similar as described for FIG. 2C, and may have a variety of decorative appearances, shapes, sizes, and architectures for a secure engagement of body 241 to panel 102.

With reference to FIG. 2F, depicted is a breakaway 260 of a top side of a common North Texas screen 250. A ram horn clip 252 (configured wire) is supported in a slot in the screen frame top rail 254 for accomplishing a retainer mechanism of the window screen 250. The retainer mechanism provides spring action with downward force exerted by the retainer mechanism when seated in the top window screen track. Some embodiments of a pet window 100 may simply use a similar design by providing a rail attached (e.g. panel edge reinforcement) at the top of panel 102 and similar ram horn clip(s) 252. Such a rail may be attached using hardware such as screws, bolts, rivets, glue, adhesive, solder, or any other attachment method.

With reference to FIG. 2G, screen retainer clip(s) 261 are slid over the top edge 140 so that panel 102 top edge 140 slides into slot 264. Topmost portion 262 provides the spring action already described above. With reference to FIG. 2H, screen retainer clip(s) 271 are slid over the top edge 140 like clip 261. Folded portion 274 must not prevent the topmost portion 272 from fitting well into the top window screen track. Both screen retainer clips 261 and 271 preferably have an angled flange 268 facing inwardly to slot 264 for providing a biting non-slip grasp of panel 102. Screen retainer clips 261 and 271 may be third party screen retainer clips 258 available for purchase, or provided as components/parts to pet windows 100.

Panel retainer(s) of a pet window 100 may be attached to, integrated with, or included as part of panel 102. In other embodiments, panel retainer(s) of a pet window 100 may be provided loose as component(s) or part(s) for a pet window 100 product which can be installed appropriately by a customer. In some embodiments, screws, bolts, or pins, are provided for outside window frame installation to firmly keep a pet window 100 in place of the window screen position. Panel retainers fixedly attach to the substantially planar panel and have a retainer portion engaging the window screen track to securely retain the substantially planar panel at least partially in the window screen track. In other embodiments, panel retainers fixedly attach to a window screen track or overall window frame area for engaging the substantially planar panel to securely retain the substantially planar panel at least partially in the window screen track (e.g. rectangular screen held in track with screen clip(s) (e.g. PrimeLine screen clips, wing clips, flush screen clips, brick clips, latches, corners, springs, or the like)). There are many varieties of window screen retainer clips, window screen retainer screws or screwed housings thereof, etc. for window screen retainer mechanisms, usually depending on building practices by geographical locations. Those skilled in the art appreciate a variety of designs to accomplish a panel retainer 200 without departing from the spirit or scope of the disclosure, including when emulating other window screen retainer mechanisms for other world geographical locations. Retainers 200 are in contact with pet window 100 (e.g. panel 102) and the window screen track or overall window frame area for receiving into the window screen track the pet window 100.

Note that panel retainers 258 (screen retainer clip(s) 261 and 271) may serve well for components of an adapter 600 when turned upside down, and perhaps with an elongated profile for elongated topmost portions 262/272 being received into the window screen track, or with topmost portions 262/272 matching window screen track height to prevent gaps as described with FIGS. 6A and 6B above. Retainer clips 261 and 271 may also serve well for components of panel edge reinforcements wherein the outer surface including topmost portions 262/272 is removed (i.e. for a rectangular “U” body profile at an appropriate elongated length).

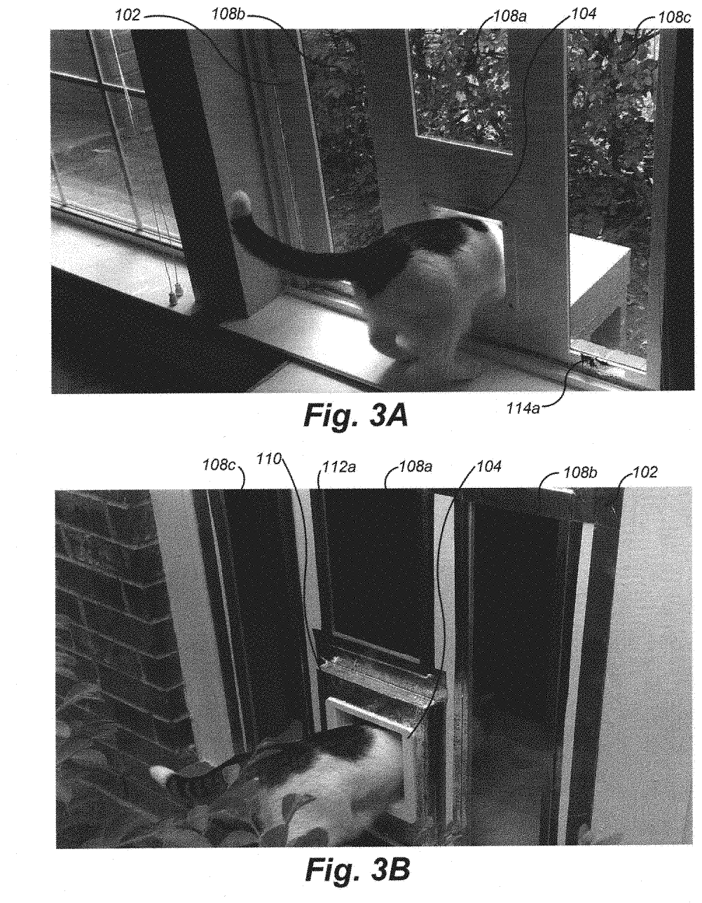

FIGS. 3A and 3B illustrate use of a pet window 100 for communicating a pet window 100 over conventional pet door installations. Despite steps provided at the inside and outside, they are not required because the window sill (interior and exterior) is low to the ground. Cats prefer to enter and leave in a secluded area of the home, for example behind a hedge near the home foundation. Pet door 104 should be the smallest reasonable size for anticipated pet use to avoid a larger animal entering the home, for example when a larger animal chases the pet. The movable window sash of FIG. 3A is in the topmost position out of view, but can be lowered as desired (e.g. to close, or to highest elevation of pet door 104 for pet window 100 use).

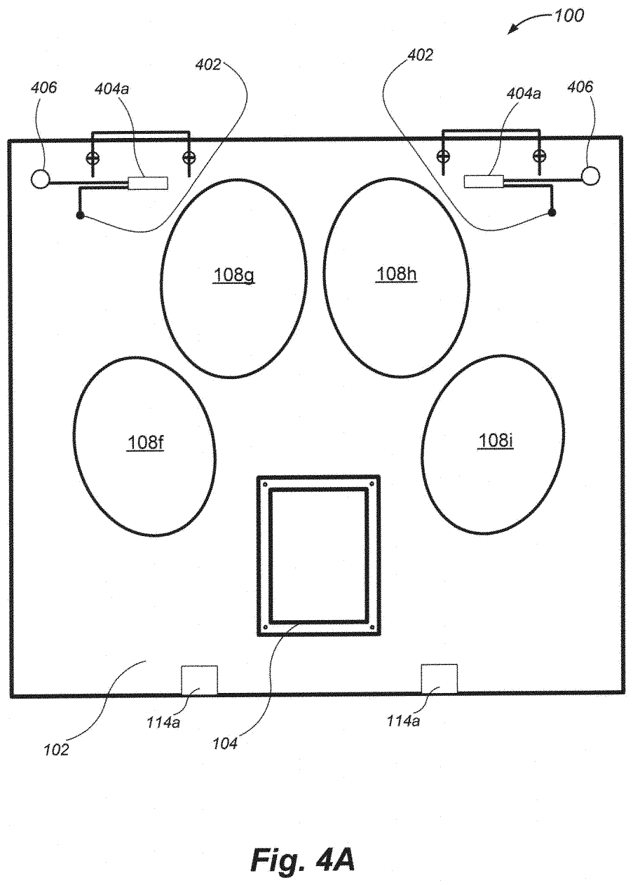

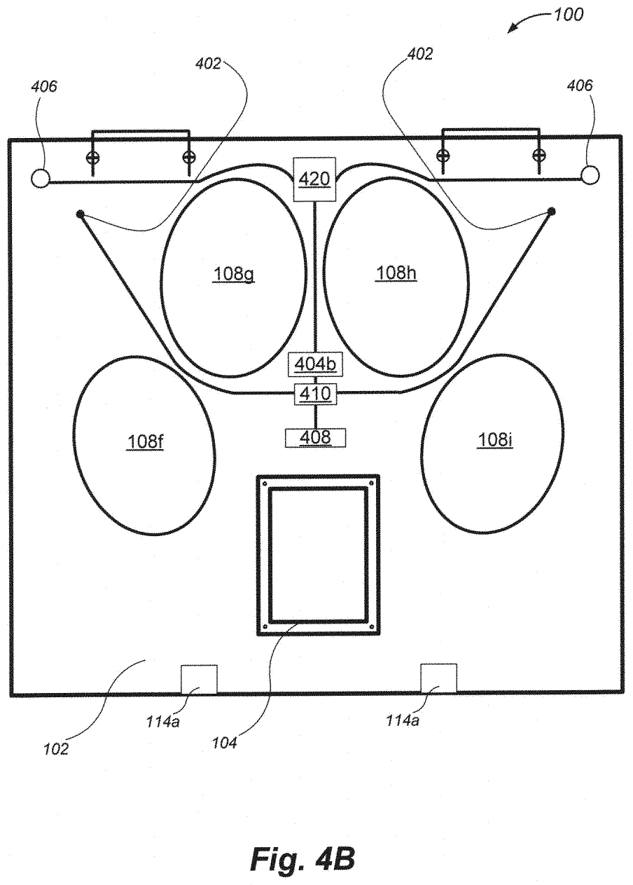

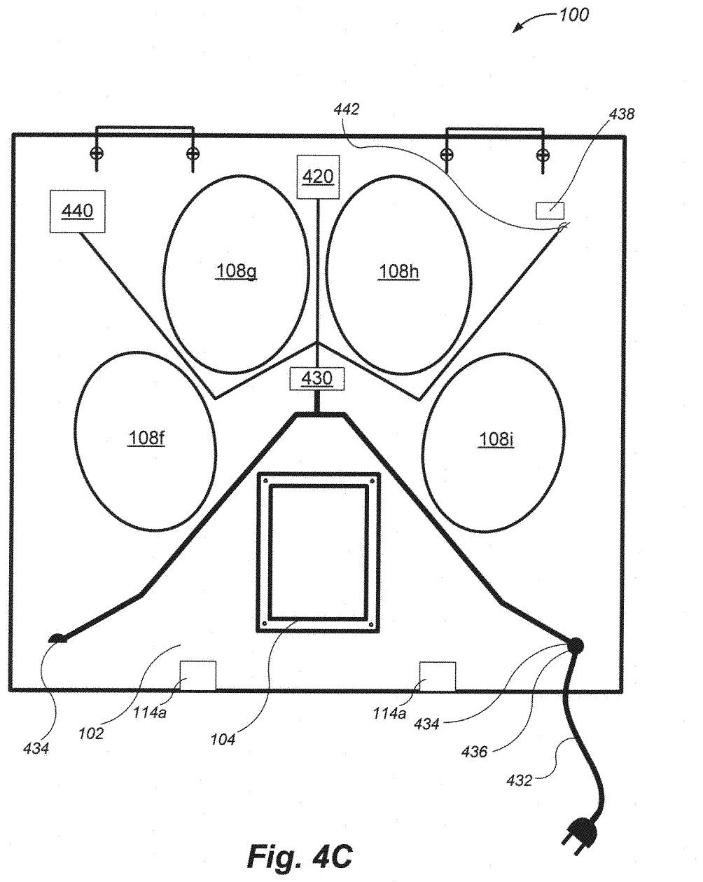

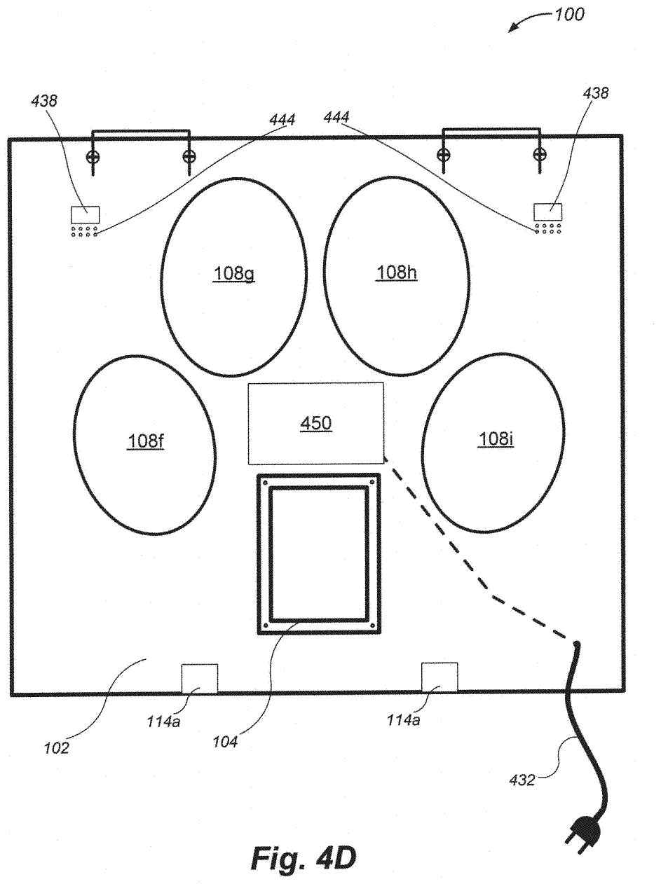

With reference now to FIG. 4A, depicted is an inside facing surface view of the third preferred embodiment of a pet window 100 to discuss other options. An LED light 144 is preferably pushed through a hole in panel 102 for lighting at the outside surface 122 and affixed to the inside facing surface 120 of panel 102, for example with an adhesive around a circumference of an LED housing flange 406 pushed up against panel 102. LED light 144 may also be affixed to the outside facing surface 122 with an adhesive (e.g. double sided adhesive). In other embodiments, LED light(s) 144 are attached (i.e. affixed, adhered, coupled, bonded, held, fastened to, stuck to, gripped, clasped, clutched, hugged, riveted, bolted, soldered, or the like) to panel 102 appropriately. LED lights have a small trunk of at least two small wires (e.g. positive and negative) which lead to a low profile DC (Direct Current) regulator 404a for regulating current from a solar panel 142, for example with a tiny resistor (and perhaps with at least one inline fuse). Hole 402 accepts a small trunk of at least two small wires (e.g. positive and negative) from a solar panel 142 on the opposite side of panel 102 to power LED light 144 through regulator 404a. LED light 144, or housing thereof, may incorporate a lumens (light) detector for powering on only at night. Solar panels 142 depicted power their own LED light 144, however multiple solar panels 142 may be connected together at inside surface 120, in parallel, or in series, depending on power requirements of LED lighting, or other powered electric appliances attached to panel 102. Individual wires, or trunks thereof, are preferably aesthetically run adjacent panel 102 (e.g. adhesive tape covering) or concealed within a layer of panel 102 itself.

In other embodiments, adaptable electric connectivity is provided to panel 102. For example, circuit board conductivity is printed to the inside surface 120 of panel 102 (e.g. wave soldering machine) and wires are soldered (welded, attached, or the like) to specific points thereof. In another embodiment, circuit board conductivity is printed to an interior layer of panel 102 (e.g. motherboard wiring) with attachment terminals (e.g. solder/welding points, terminal posts, terminal slots for holding wire ends, or the like) identified at inside surface 120. A well designed and flexible circuit pattern with a choice of attachment terminals is available for conveniently customizing electric appliance(s) to panel 102. Cavities, or holes in panel 102 with weather proofed protruding compartments at outside surface 122 (preferably in an artistic manner and complementary of any theme), may be provided in one or more panel 102 locations as complementary to attachment terminals. When solar panels are used, an appropriate electrical circuit is incorporated, preferably with an aesthetic appearance (e.g. aesthetic wire runs respective panel 102 options and decorations, also preferably covered by thin decorative adhesive tape if not workable artistically into a pet window 100 theme) if exterior to panel 102, or by using panel 102 interior wiring, or by circuitry printed on or within panel 102 for appliance connectivity options. Thus, the various electric connectivity options of panel 102 embodiments is referred to as panel 102 having adaptable electric connectivity. The adaptable electric connectivity is provided to panel 102 with an aesthetically pleasing (e.g. artistic theme), and symmetric appearance, if not concealed within panel 102. Some embodiments for internal wiring of panel 102 is cat 5E or cat 6, each with 8 uniquely colored wires, and sandwiched between manufactured layers in forming panel 102 and optional squeezed accessory windows 108 thereof. The wire ends of trunks (i.e. cat 5E or cat 6) are passed through panel 102 to inside surface 120 in the vicinity of an appliance attachment support 438 wherein the wire ends can be attached to the appliance.

Adaptable electric connectivity includes connectivity between sub-panels 102 at seams 160 when applicable. For example, internal or external wiring or circuitry preferably includes electric circuit contact points at adjacent sub-panel 102 edges for conductivity crossing a seam 160. Such contact points may include terminals that can be snapped together or mated together as male/female connections, or designed to stay in firm contact when sub-panels are installed adjacent each other. In more primitive embodiments, wire ends are exposed at seams 160 for being connected (e.g. twisted together by installer) to conduct electricity across a seam 160. Sub-panel 102 embodiments by design preferably eliminate or minimize the number of seam aligned electric circuit contact points required to conduct electrical current across a seam 160. In other embodiments, adaptable electric connectivity required to cross a seam 160 is purposely exposed in part, or its entirety, to an exterior surface of panel 102 for manual connection. In some preferred embodiments, panel 102 connections as described above additionally provide the required electrical contact between sub-panels 102.

Regulator 404a preferably has a connected rechargeable battery therewith when solar panel(s) 142 are not equipped to store their own charge. LED lights 144 have low power consumption, and therefore may simply have a replaceable battery for power in regulator 404a (e.g. no solar panel, nor connectivity thereof, required). Regulator 404a regulates electric current to an LED 144, while also regulating current to properly charge the rechargeable battery (if applicable). Various electrical configurations are well known to those skilled in the art. Regulator 404a may be covered and concealed in a cavity recessed into panel 102, or a hole in panel 102 protected from weather on outside surface 122, to make room for electric components/parts therein while preventing interference with window sash operation via dimension 136.

Panel 102 may also be packaged with one or more gauges, for example to determine outside weather conditions. Said gauges (e.g. thermometer, barometer, hygrometer, or other gauges) can be attached to outside surface 122 for viewing through an accessory window 108, or attached to an accessory window 108. Gauges may be attached to inside surface 120 with outside sensing accessed through weather tight hole(s) in panel 102, provided there is no interference with window operation via dimension 136 (e.g. may use complementary recessed areas into panel 102). Gauges may be built or recessed into panel 102, or provided by a third party in a pet window 100 configuration for sale. Gauges may be mechanical, battery operated, or provided with an electric source of power from solar panels 142, or AC (Alternating Current) adapted to panel 102 (see FIGS. 4C and 4D). Gauges may make use of panel 102 adaptable electric connectivity.

With reference now to FIG. 4B, depicted is an inside facing surface view of the third preferred embodiment of a pet window 100 to discuss other options. An LED light 144 is preferably installed to panel 102 as described for FIG. 4A. LED lights 144 have a small trunk of at least two small wires which lead to an internally controlled switch of motion detector 420. Motion detector 420 is substantially in majority on outside surface 122. Motion detector 420 controls lighting of LEDs 144 upon motion detection during outside darkness. Regulator 404b regulates current from solar panel(s) 142 accessible by at least two wires (trunk preferred) through hole 402 which accepts the small trunk of at least two small wires (e.g. positive and negative) from a solar panel 142 on the opposite side of panel 102 to power motion detector 420. Motion detector 420 preferably incorporates a lumens (light) detector for powering on, or switching on, LED lighting at night. Multiple solar panels 142 shown are connected together at inside surface 120, in parallel, or in series, in patch panel 410, depending on power requirements of motion detector 420. Regulator 404b is also connected to a rechargeable battery 408 through patch panel 410 for powering motion detector 420 at night when solar cells are not producing power. Patch panel 410 may facilitate directing wire ends in a patch panel housing (e.g. wire end retaining slots) for routing to components/parts (e.g. to/from 420, 142, 404b, 408), or patch panel 410 may be a primitive “home run” for twisting wires together. Exposed wires, or trunks thereof, are preferably aesthetically run adjacent panel 102 as shown (e.g. thin adhesive covering). As described above (i.e. adaptable electric connectivity), wiring embodiments may be concealed within a layer of panel 102 itself, or as printed circuit board connectivity provided to the inside surface 120 or inner layer of panel 102. Wiring of FIG. 4B is artistically provided to panel 102 in the symmetrical form of a cat's head to be consistent with the artistic feline theme of pet window 100.

LED(s) 144 may not be required wherein motion detector 420 is already equipped with its own lighting as seen in various third party devices (i.e. therefore wiring trunks shown thereto also not required). Various electrical configurations are well known to those skilled in the art. Regulator 404b, patch panel 410, and rechargeable battery 408 may be covered and concealed in a cavity recessed into panel 102, or a hole in panel 102 protected from weather on outside surface 122, to make room for electric components/parts therein (i.e. prevent interfering with movable window sash operation via dimension 136). In other embodiments, a single cavity houses 404b, 410, and 408. Motion detector 420 and LED lights 144 are electric appliances powered by solar panel(s) 142. When solar panels are not present at outside surface 122, a suitable battery may be used, and perhaps without need for components/parts 404b, 408 and patch panel 410 (i.e. no hole(s) 402 and no wire trunks shown leaving hole(s) 402). Alternatively, the battery may be coupled or integrated directly in motion detector 420.

With reference now to FIG. 4C, depicted is an inside facing surface view of a modified version of the third preferred embodiment of a pet window for discussing options. Modifications are no solar panels 142, no LEDs 144, and no wiring thereof. Motion detector 420 having its own lighting is powered by an electric transformer 430 which in turn is plugged into a home AC (Alternating Current) outlet with AC plug terminated AC wire 432. Transformer 430 may be covered and concealed in a cavity recessed into panel 102, or a hole in panel 102 protected from weather on outside surface 122, to make room for it (i.e. prevent interfering with movable window sash operation via dimension 136). AC wire 432 is interchangeably made available at either side by connecting 1 of 2 connection 436 of wire 432 (e.g. male plug with 3 prongs) to 2 of 2 connection 434 (e.g. female socket for 3 prongs), and may be of any length with the plug terminator, and wiring thereof, adapted for a variety of electric outlets. Providing plug options at either side of pet window 100 facilitates a beautiful symmetric appearance while providing flexibility. Further installed to panel 102 is an alarm clock 440 (i.e. electric appliance) which alternatively could be battery powered or solar powered, for example to announce to a pet when to eat, or when to return home, and on a schedule. In some embodiments, transformer 430 may power a plurality of electric appliances attached to panel 102 for a variety of purposes, with adaptable electric connectivity (i.e. wiring, or internal/external panel layered wiring, or printed circuit board connectivity described above). In various embodiments, alarm clock 440 preferably supports setting a plurality of distinct alarms. Alarm clock 440 may be battery operated, DC powered, AC powered, and may provide its own electricity regulation. Alarm clock 440 may be attached to panel 102 using Velcro, for example panel 102 appliance attachment supports 438 (i.e. 1 of 2 adhesive backed Velcro piece) for attaching various electric appliances having a matching 2 of 2 Velcro piece affixed thereon. Appliance attachment supports 438 are provided for convenience and adaptable electric connectivity 442 provides appropriate connectivity options (i.e. connectable power wires 442, connectable routing wires 442, circuitry internal/external with connectivity 442 revealed on the inside surface 120 (e.g. weld points, terminal posts, wire insert-able slots, or wire ends as shown)) in the vicinity of an appliance attachment support 438 for convenient electric appliance connectivity. Some attachment support embodiments 438 are pockets, shelves, straps, or any other electric appliance attachment support of pet window 100. Any option (device 450, system, apparatus, gauge, light, or other device) of panel 102 which consumes electricity (AC or DC) is considered an “electric appliance”.

With reference now to FIG. 4D, depicted is an inside facing surface view of a modified version of the third preferred embodiment of a pet window 100 for discussing options. Modifications are no solar panels 142, no LEDs 144, no motion detector 420, and no wiring thereof. Computing device, for example a tablet, an iPad, a smartphone, or other data processing system device 450 may be installed, or may be conveniently placed at rest in position against an appliance attachment support 438 (clips, Velcro, shelf, or the like) of panel 102. Device 450 can provide a display for the pet and/or pet owner with a graphical image or video, for example being associated with the weather outside. Images reflective of the weather, perhaps as made available from a weather web site (e.g. wireless internet connectivity to Device 450) can be displayed in real time, for example when there are radiant barrier coated accessory windows 108, no accessory windows 108, or poor visibility through panel 102 to the outside. Device 450 may be battery operated or solar powered as well. Attachment support 438 used by device 450 facilitates a place to charge device 450. Device 450 provides many options for useful applications like an alarm clock application, pet friendly music/video/sound play, pet meow or bark control (i.e. voice control, for example as trained with pet's voice), etc. Device 450 may also be adapted to interface with many different options to panel 102 (e.g. lights, pet door 104 operation (e.g. detecting with discrete switch and direction of pet door 104 moving part whether pet is in or out, and how often for each). Wired or wireless connectivity may be used. Device 450 is an electric appliance and is the brain for a plurality of useful functions. Appliance attachment support(s) 438 can be used for other electric appliances that communicate with device 450 via wireless or wired. Adaptable electric connectivity of FIG. 1D is internal to panel 102 (e.g. circuitry printed to an internal layer, or wiring run internal to panel 102) with contact points 444 (e.g. terminal posts or wire end insert-able slots that hold wire) exposed and identified (e.g. marked for guiding use) to inside surface 120 in the vicinity of appliance attachment supports 438. For example, device 450 may be plugged into AC wire 432 in the vicinity of appliance attachment support 438 (not shown) used by device 450. Alternatively, a USB cable runs via panel 102 to power device 450. Internal adaptable electric connectivity enables a beautiful appearance to inside surface 102. AC wire 432 is internal to panel 102 except where it exits panel 102 at the lower right hand side. AC wire 432 may be provided to either side of panel 102 with little lack of symmetry because electric circuits are concealed within panel 102. Attachment support 438 areas may be recessed, and perhaps with attachment support 438 therein.

When panel 102 adaptable electric connectivity is visible (i.e. not within panel 102 or layer thereof), FIGS. 4A through 4D depict symmetrical aesthetic wiring with thin tape coverings against panel 102. Visible wiring should be pleasing to the eye for a beautiful appearance, and in many cases is placed to accentuate a decorative theme (like feline example above). Power embodiments discussed may support a pet door 104 recognizing a pet using a beacon, RFID, etc. via a pet collar recognized by a data processing system associated with the pet door 104. Adaptable electric connectivity wiring may provide power, device communications connectivity, device interoperability connectivity, or other reasonable connectivity options for maximizing useful pet window 100 features, some for better integration with technology of hosted pet doors 104.

In another embodiment, pet door 104 may be equipped with pet door directional open/close detection device(s) such as a limit switch, a plunger switch, a push-button switch, a magnetic contact switch, a light wave projection detector, etc, for example as provided by adjacent portions, components, features, or attachments of pet window 100. The direction of pet door 104 actuation detected with the directional open/close detection device may be used to provide an integrated or connected data processing system with status of whether a pet is in, out, and how pet window 100 is being used by the pet. The integrated or connected data processing system will indicate status to a display thereof, light an LED light for indication at inside surface 120, change color of an LED light at inside surface 120, or provide pet ingress/egress status in a variety of suitable manners.

Similarly, a Raspberry Pi or other micro-PC may be attached to panel 102 at time of sale, with adaptable electric connectivity of panel 102 (e.g. if wireless not used), to achieve desired features and functionality. A recess or hole in panel 102 (protected from outside weather conditions) may conceal and provide convenient access to the micro-PC at inside surface 120. An aesthetic protruding weather safe pocket may be included at outside surface 122 to prevent interference with opening and closing the movable window sash adjacent pet window 100 via dimension 136.

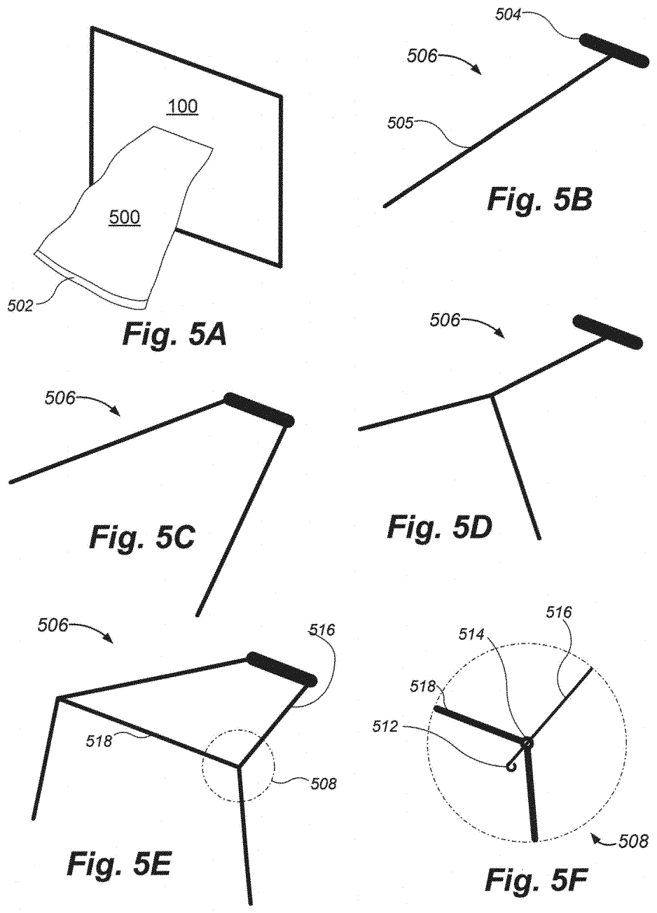

With reference now to FIGS. 5A through 5F, depicted is embodiments for discussing pet window awning options. Pet window 100 in FIG. 5A may include an exterior awning 500 attached to panel 102 adjacent awning attachment support 150 (e.g. Velcro 1 of 2) using a matching piece of Velcro 2 of 2 (e.g. exterior awning 500 having hooks and 150 having loops, or visa-versa). Attachment support 150 may or may not be designed to span a plurality of sub-panels 102. Pet window 100 in FIG. 5A is assumed to have solar panels (e.g. FIG. 1D 142) wherein exterior awning 500 should not block solar panel use. Awning 500 is preferably a water resistant fabric, canvas, sheet, or the like of a suitable material for outdoor use and shaped appropriately to provide at least shade to a pet exiting to outdoors, for example to an adjacent makeshift step. In some embodiments, the fabric of awning 500 has a weighted seam 502 for keeping the far end of the fabric against the ground in such a way as to provide desired slack (e.g. sand, marbles, pebbles, rocks, a lead or other heavy metal strip, customer provided weighting means inserted into seam 502 (e.g. via zipper, pocket or other access), or the like). Awning 500 may also be a rigid material (e.g. board, plank, panel, or the like, manufactured of material like panel 102) attached (secured) against panel 102, for example at awning attachment support 150.

With reference to FIG. 5B, awning 500 may also be supported by an awning support skeleton 506, for example having an attachment apparatus 504 (e.g. Velcro 2 of 2) and at least one skeletal member 505 integrated thereon for supporting a flexible awning 500 fabric. Awning 500 may be attached (i.e. affixed, adhered, coupled, bonded, held, fastened to, stuck to, gripped, clasped, clutched, hugged, riveted, bolted, soldered, or the like) to panel 102 in any reasonable manner. Skeletal member(s) 505 may be attached (i.e. affixed, adhered, coupled, bonded, held, fastened to, stuck to, gripped, clasped, clutched, hugged, riveted, bolted, soldered, or the like) to attachment apparatus 504 in any reasonable manner. Depending on embodiments, any number of skeletal members 505 may be incorporated.

With reference to FIGS. 5C and 5D, awning 500 may also be supported by an awning support skeleton 506 having two members 505 (e.g. two straight rails in FIG. 5C with ends to ground, one top rail with a V shaped leg design rail in FIG. 5D). With reference to FIG. 5E, awning 500 may also be supported by any plurality of skeletal members 505 (e.g. two straight rails with a U shaped leg design rail having two feet contact the ground). Rails (skeletal members 505) may be welded metal or plastic (or reasonable heavy gauge wire), for example as desired for a customized pet window 100. Alternatively, a convenient attachment (i.e. affixing, adherence, coupling, bond, hold, fastening, grip, clasp, clutch, hug, rivet, bolt, solder, or the like) is provided, for example for customer use after sale of a mass produced pet window 100. One embodiment of a convenient attachment for members 505 is shown in focus area 508. Focus area 508 of FIG. 5F magnifies the joining attachment wherein all members 505 (i.e. rails) have hooked ends 512 and all bend joints have eyelets 514 for receiving a member 505 for a hooked attachment. A hand-tool may be used to further close the gap in a hook 512 if necessary after passing through an eyelet 514. Any of the embodiments in FIGS. 5A through 5F may be secured at the top of panel 102 when no solar panels are used via a suitable awning attachment support 150 being made available appropriately on panel 102, or alternatively to retainer(s) 200 or panel edge reinforcement(s).

Exterior awning 500 does not need a Velcro attachment support 150 wherein upper corners of an appropriately sized awning are tucked between bar 208 and panel 102 when retainer 106 is in place. Alternatively, a hook 512 is easily secured to bar 208 (or to hooks described above taking place of bar 208). There are many awning 500 embodiments, some having supporting skeletons to support a suitable fabric as described above for tent-like features to disperse and provide cover from rainfall and provide shade, albeit with enough area at the outside of pet window 100. In other embodiments, awning 500 is a rigid covering providing shade and shelter at the outside of pet window 100. In some preferred embodiments, skeletal member(s) 505 (e.g. heavy gauge wire) may be manually bent to form into desired configurations and placements.

A pet window 100 product for sale consists of components (or parts) including: a panel 102 (or plurality of sub-panels 102), a passageway 103 of panel 102, and at least one panel retainer 200. In many embodiments, shim block 110 is also provided to accommodate at least one pet door 104. Further provided may be any of the features (i.e. options, attributes, characteristics, or the like) and parts thereof described above, including a pet door 104 itself, all of which are components.

Company name and/or product name trademarks used herein belong to their respective companies.

While various embodiments of the present disclosure have been described above, it should be understood that they have been presented by way of example only, and not limitation. Thus, the breadth and scope of the present disclosure should not be limited by any of the above-described exemplary embodiments, but should be defined only in accordance with the following claims and their equivalents.

What is claimed is:

1. An article of manufacture for hosting a pet door, comprising:
a combinative apparatus including a plurality of substantially planar panels adjacent each other, the combinative apparatus having dimensions sized for replacing a window screen adjacent a movable window sash, the combinative apparatus:
fitting securely into a window screen track for receiving the window screen, and
being at least partially secured within the window screen track by at least one panel retainer wherein the movable window sash remains fully operable adjacent the combinative apparatus, the panel retainer emulating mechanical operation of a retaining mechanism of the window screen; and
a passageway in the combinative apparatus sized for accepting installation of the pet door.

2. The article of manufacture of claim 1 including a shim block, the shim block:
positioned adjacent the combinative apparatus on an outside surface of the combinative apparatus upon installation of the pet door, and
providing a profile dimension matching wall thickness specifications of the pet door.

3. The article of manufacture of claim 2 including installation of the pet door.

4. The article of manufacture of claim 1 including at least one attached installation facilitator for installation of the article of manufacture into, and removal from, the window screen track.

5. The article of manufacture of claim 1 including at least one accessory window.

6. The article of manufacture of claim 1 including a solar panel.

7. The article of manufacture of claim 1 including a window screen track adapter.

8. The article of manufacture of claim 1 including a panel edge reinforcement.

9. The article of manufacture of claim 1 including a battery.

10. The article of manufacture of claim 1 including at least one LED light.

11. The article of manufacture of claim 1 including at least one substantially planar panel exceeding a dimension of the window screen track.

12. The article of manufacture of claim 1 including at least one gauge.

13. The article of manufacture of claim 1 including an exterior awning.

14. The article of manufacture of claim 1 including adaptable electric connectivity.

15. The article of manufacture of claim 1 including an alarm clock.

16. The article of manufacture of claim 1 wherein the plurality of substantially planar panels includes a substantially planar panel having at least one foam layer.

17. The article of manufacture of claim 1 wherein the plurality of substantially planar panels are coupled together with a mating engagement.

18. The article of manufacture of claim 1 including markings for guiding customization.

19. A pet window for hosting a pet door, comprising:
a combinative apparatus including a plurality of substantially planar panels adjacent each other, the combinative apparatus having dimensions sized for replacing a window screen adjacent a movable window sash, the combinative apparatus:
fitting securely into a window screen track for receiving the window screen, and
being at least partially secured within the window screen track by at least one panel retainer wherein the movable window sash remains fully operable adjacent the combinative apparatus, the panel retainer emulating mechanical operation of a retaining mechanism of the window screen; and
a passageway in the combinative apparatus sized for accepting installation of the pet door.

20. A system for hosting a pet door, comprising:
a combinative apparatus including a plurality of substantially planar panels adjacent each other, the combinative apparatus having dimensions sized for replacing a window screen adjacent a movable window sash, the combinative apparatus:
fitting securely into a window screen track for receiving the window screen, and
being at least partially secured within the window screen track by at least one panel retainer wherein the movable window sash remains fully operable adjacent the combinative apparatus, the panel retainer emulating mechanical operation of a retaining mechanism of the window screen;
a shim block;
a passageway in the shim block sized for accepting installation of the pet door; and
a passageway in the combinative apparatus sized for accepting installation of the pet door.
